(19) United States
(12) Patent Application Publication
(10) Pub. No.: US 2020/0051181 A1
(43) Pub. Date: Feb. 13, 2020

(54) SYSTEM AND METHOD FOR SUPPORTING PRODUCTION MANAGEMENT

(71) Applicant: Hitachi, Ltd., Tokyo (JP)

(72) Inventors: Takanori MORITOMO, Tokyo (JP); Kenichirou KAWAKAMI, Tokyo (JP); Shigeyasu KUBO, Tokyo (JP)

(21) Appl. No.: 16/354,581

(22) Filed: Mar. 15, 2019

(30) Foreign Application Priority Data
Aug. 9, 2018 (JP) 2018-150902

(51) Int. Cl. G06Q 50/04; G06Q 10/06

(52) U.S. Cl. CPC G06Q 50/04; G06Q 10/0633

(57) ABSTRACT

A production management supporting system specifies, for each of one or more times during a display target period and on a per inter-step and/or intra-step range basis, a retention number as the number of products present at the time on the basis of past record information, for each product loaded in a production line, an execution time of each of the steps and that serves as a basis for a diagram chart showing a production situation. The system determines whether or not one or more retention situations satisfies a predetermined requirement and performs, when there is the satisfying retention situation, accentuated display of a target portion that is a portion, of the diagram chart, which corresponds to an inter-step range and/or an intra-step range in which the satisfying retention situation has occurred and to a period having the satisfying retention situation.

### CROSS-REFERENCE TO PRIOR APPLICATION

This application relates to and claims the benefit of priority from Japanese Patent Application number 2018-150902, filed on Aug. 9, 2018 the entire disclosure of which is incorporated herein by reference.

### BACKGROUND

The present invention relates generally to a computer technique for supporting production management.

In production, it is common to sequentially load a plurality of products into a production line and sequentially perform a plurality of steps on each of the products. In general, it is desirable to bring as many products as possible into a shippable state per unit time so that products are successively loaded into a production line in a short period of time. This results in numerous management targets and therefore a heavy burden on production management for recognizing an abnormality occurring in a production process in the production line and reliably preventing shipment of defective products.

As a means for reducing the burden, the technique disclosed in PTL 1 is known. The technique disclosed in PTL 1 visually recognizably displays a production period and a wait period for each step. For example, according to FIG. 4 in PTL 1, a display apparatus connects, for each product, the starting times of a plurality of steps with a line and connects, for each product, the ending times of the plurality of steps with a line. For example, according also to FIG. 22 in PTL 1, the display apparatus provides, for each step, a starting time axis and an ending time axis and connects, for each product, the starting time of each step, the ending time of the step, and the starting time of the subsequent step with a line. For example, according also to FIGS. 23 and 24 in PTL 1, the display apparatus counts, from the number of products crossing a line perpendicular to a time axis, an intermediate stock quantity, which is the number of products present in the steps from the first step to the last step, and determines that there is an abnormality when the intermediate stock quantity is large.

[PTL 1] Japanese Patent No. 6287018 (Specification)

### SUMMARY

FIGS. 4 and 22 in PTL 1 allow a production period and a wait period for each of the products to be visually recognized. FIGS. 23 and 24 in PTL 1 allow the intermediate stock quantity, which is the number of the products present in the plurality of steps from the first step to the last step, to be counted.

However, PTL 1 has a problem in that it is difficult for a user to recognize a situation in each inter-step range and/or in each intra-step range for a relatively large number of products as the whole. The recognition of the situation in each inter-step range and/or in each intra-step range in terms of production management of a production line is considered to be among important issues in holding the whole production line in an appropriate state.

A production management supporting system specifies, for each of one or more times during a display target period and on a per inter-step and/or intra-step range basis, a retention number as the number of products present at the time on the basis of past record information that includes information as a past record which shows, for each product loaded in a production line in which a plurality of steps are performed, an execution time (at least one of a starting time and an ending time) of each of the steps and that serves as a basis for a diagram chart showing a production situation. The system determines whether or not one or more retention situations in accordance with the retention number specified for each of the foregoing one or more times on a per inter-step and/or intra-step range basis include a retention situation satisfying a predetermined requirement. When there is the satisfying retention situation, the system performs accentuated display of a target portion that is a portion, of the diagram chart, which corresponds to an inter-step range and/or an intra-step range in which the satisfying retention situation has occurred and to a period having the satisfying retention situation. Note that the diagram chart is a polygonal line graph having a first axis and a second axis perpendicular to the first axis. The first axis corresponds to time. The second axis corresponds to the steps. The diagram chart has a polygonal line for each product for which at least one of the plurality of steps has the execution time belonging to the display target period. A point on each polygonal line corresponds to the step and the execution time of the step.

It is possible to recognize a situation in each inter-step range and/or in each intra-step range for each of a relatively large number of products.

### BRIEF DESCRIPTION OF THE DRAWINGS

FIG. 1 shows the outline of an embodiment;

FIG. 2 shows a configuration of a production management supporting system according to the embodiment;

FIG. 3 shows an example of functions implemented in a management server;

FIG. 4 shows an example of a diagram chart screen;

FIG. 5 shows a past record table;

FIG. 6 shows an event table;

FIG. 7 shows the flow of a display control process related to a display mode (m1);

FIG. 8 shows the outline of an example of retention number calculation;

FIG. 9 shows a retention number table;

FIG. 10 is an illustrative view of an example of retention number calculation;

FIG. 11 shows an example of display of a trouble high frequency step;

FIG. 12 shows an example of display of affected intervals;

FIG. 13 shows an example of display of events;

FIG. 14 shows an example of display of the changing tendency of retention;

FIG. 15 shows another example of the display of the changing tendency of retention;

FIG. 16 shows a retention period table;

FIG. 17 shows a changing tendency table;

FIG. 18 is an illustrative view of an example of changing tendency calculation;

FIG. 19 shows an analysis time block table;

FIG. 20 is an illustrative view of an example of updating of the analysis time block table;

FIG. 21 shows an example of a diagram chart displaying the execution time (starting time or ending time) of each of steps instead of displaying both of the starting time and the ending time of each of the steps;

FIG. 22 shows an example of accentuated display of a line segment subsequent to an inter-step range (or an intra-stage range) in which a retention period equal to or larger than a threshold has occurred for a product corresponding to the retention period equal to or larger than the threshold; and

FIG. 23 is a schematic diagram showing the definition of a blank region.

### DESCRIPTION OF EMBODIMENTS

The following will describe an embodiment of the present invention.

In the following description, an “interface portion” includes one or more interfaces. The one or more interfaces may include at least one of a user interface portion and a communication interface portion. The user interface portion may include at least one I/O device among one or more I/O devices (e.g., input devices (e.g., a keyboard and a pointing device) and an output device (e.g., a display device)) and a display computer or may include an interface device for the at least one I/O device. The communication interface portion may include one or more communication interface devices. The one or more communication interface devices may be one or more communication interface devices of the same type (i.e., one or more network interface cards (NICs)) or two or more communication interface devices of different types (e.g., a NIC and a host bus adapter (HBA)).

In the following description, a “storing portion” includes one or more memories. At least one of the memories associated with the storing portion may appropriately be a volatile memory. The storing portion is used mainly during a process performed by the processor portion. The storing portion may also include, in addition to the memories, one or more nonvolatile storing devices (e.g., hard disk drives (HDDs) or solid state drives (SSDs)).

In the following description, the “processor portion” includes one or more processors. At least one of the processors is typically a microprocessor such as a central processing unit (CPU), but the processors may also include a processor of another type such as graphics processing unit (GPU). Each of the one or more processors may be a single-core processor or a multi-core processor. The processors may also include a hardware circuit which performs a part or the whole of a process.

In the following description, a process may be described using a “program” as a subject. Since a program performs a determined process by being executed by the processor portion, while appropriately using the storing portion (e.g., memory), the interface portion (e.g., communication port), and/or the like, the subject of the processor may also be the processor. The process described using the program as the subject may also be a process performed by the processor portion or an apparatus having the processor portion. The processor portion may also include a hardware circuit (e.g., field-programmable gate array (FPGA) or an application specific integrated circuit (ASIC)) which performs a part or the whole of the process. The program may also be installed from a program source to an apparatus such as a computer. The program source may be, e.g., a program distribution server or a recording medium (e.g., non-transitory recording medium) which is readable by the computer. In the following description, two or more programs may be implemented as one program or one program may be implemented as two or more programs.

In the following description, information may be described using such an expression as “a xxx table”, but the information may be expressed using any data structure. Specifically, to show that the information does not depend on any data structure, “a xxx table” can be referred to also as “xxx information”. Also, in the following description, a configuration of each table is exemplary. One table may be divided into two or more tables or all or any of two or more tables may be one table.

In the following description, a “production management supporting system” may be configured to include one or more computers. Specifically, when, e.g., a computer has a display device and displays information on the display device thereof, the computer may appropriately be the production management supporting system. Alternatively, when, e.g., a first computer (e.g., management server) transmits information to be displayed to a remote second computer (display computer (e.g., management client)) and the display computer displays the information (when the first computer displays the information on the second computer), at least the first computer of the first and second computers may appropriately be the production management supporting system. The production management supporting system may also have an interface portion, a storing portion, and a processor portion coupled to the interface portion and the storing portion. The interface portion may appropriately be at least one of a user interface portion and a communication interface portion. The user interface portion may be at least one I/O device among one or more I/O devices (e.g., input devices (e.g., a keyboard and a pointing device) and an output device (e.g., a display device)) and the second computer. The communication interface portion may appropriately be one or more communication interface devices. The “display of information to be displayed” by the computer in the production management supporting system may be the display of information to be displayed on the display device of the computer or may also be the transmission of the information to be displayed from the computer to the display computer (in the latter case, the display computer displays the information to be displayed). The function of at least one of the management server in the production management supporting system and the production management supporting system may also be implemented by a virtual computer (e.g., virtual machine (VM)) implemented by at least one physical computer (e.g., a physical calculation resource on a cloud basis). At least a portion of the production management supporting system may be software-defined.

When the following description is given without discriminating elements of the same type from each other, the common portions of reference signs may be used while, when the following description is given while discriminating elements of the same type from each other, the reference signs may be used. For example, when bands are not discriminated from each other, each of the bands may be referred to as a “band 160”. When the bands are discriminated from each other, each of the bands may be referred to as an “intra-step band 160A” or “inter-step band 160B”. When the bands are further discriminated from each other, each of the bands may be referred to as an “intra-step band 160A1” or “intra-step band 160A2”, or alternatively referred to as an “inter-step band 160B1” or “inter-step band 160B2”.

A “product” generally means a produced item, i.e., a finished product. However, in the following description, the “product” means each of the items loaded in a production line. Accordingly, in the following description, the “product” may be any of an item before loaded into the production line, an item currently in the production line (i.e., “semi-finished product”), and a finished product in a shippable state through all the steps in the production line.

Also, in the following description, the intra-step range of a step x (x is a natural number) may be referred to as an “intra-step range x”, while an inter-step range between the step x and a step (x+1) may be referred to as an “inter-step range x−(x+1)”.

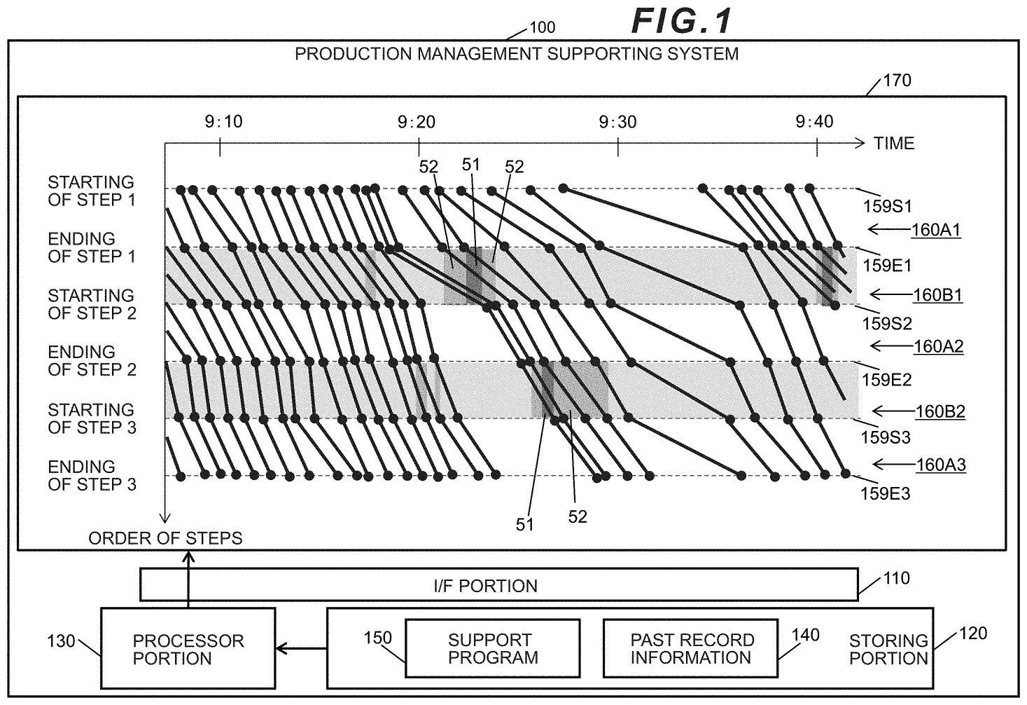

FIG. 1 shows the outline of the embodiment.

A production management supporting system 100 has an I/F (interface) portion 110, a storing portion 120, and a processor portion 130 coupled to the I/F portion 110 and the storing portion 120. The storing portion 120 stores past record information 140 and a support program 150.

The past record information 140 include information showing the past record of production, specifically, e.g., information showing an execution time of each of steps for each product loaded in a production line. The execution time of the step may be one or more times selected between the starting time of the step and the ending time thereof in accordance with a predetermined rule. In the present embodiment, both of the starting time and the ending time are adopted.

The support program 150 performs visualization of a production situation as one of supports for production management. Specifically, the support program 150 analyzes the past record information 140 by being executed by the processor portion 130 and displays a diagram chart 170 showing the production situation on the basis of the result of the analysis. The diagram chart 170 is a so-called polygonal line graph. In the chart 170, an abscissa axis (an example of a first axis) corresponds to time, an ordinate axis (an example of a second axis) corresponds to the steps, and one polygonal line corresponds to one product. In the following description, the abscissa axis is referred to as a “time axis”, while the ordinate axis is referred to as a “step axis”.

In the chart 170, in the sequential order of the steps, starting axes 159S each corresponding to a starting time and parallel with the time axis and ending axes 159E each corresponding to an ending time and parallel with the time axis are alternately arranged along a direction parallel with the step axis (i.e., direction perpendicular to the time axis). Consequently, the intra-step bands 160A and the inter-step bands 160B are alternately arranged along a direction parallel with the step axis. For each product, the point on each of the starting axes 159S corresponds to the starting time of the step for the product corresponding to the starting axis 159S. Also, for each product, the point on each of the ending axes 159E corresponds to the ending time of the step for the product corresponding to the ending axis 159E. Note that the “intra-step band” is the belt-like region extending in parallel with the time axis from the starting axis 159S to the ending axis 159E and corresponding to the intra-step range from the starting of a step to the ending of the step. The “inter-step band” is the belt-like region extending in parallel with the time axis from the ending axis 159E to the starting axis 159S and corresponding to the inter-step range from the ending of the step to the starting of the subsequent step.

The support program 150 specifies, for each of one or more times in a display target period and on a per inter-step (and/or intra-step) range basis, a retention number as the number of products present at the time on the basis of the past record information 140. The “each of one or more times” mentioned herein may be each of the times during the display target period (e.g., the times each corresponding to a unit time) or the time specified by the user using a pointing device or the like during the display target period. The support program 150 determines whether or not one or more retention situations in accordance with the retention number specified for the one or more times on a per inter-step (and/or intra-step) range basis include a retention situation satisfying a predetermined requirement. When there is the satisfying retention situation, the support program 150 performs accentuated display of a target portion that is the portion of the diagram chart 170 corresponding to the inter-step range (and/or intra-step range) in which the satisfying retention situation has occurred and to a period having the satisfying retention situation. This allows the user to recognize (visually recognize), for a relatively large number of products as the whole, the situation in each inter-step range (and/or in each intra-step range).

Note that the “accentuated display of the target portion” may be the display of a display object having a length corresponding to the period having the satisfying retention situation along a direction of the time axis such that the display object overlaps a line segment (a portion of the polygonal line) over the inter-step band 160B (or intra-step band 160A) corresponding to the inter-step range (or intra-step range) in which the satisfying retention situation has occurred or the like. In the present embodiment, the “accentuated display of the target portion” is accentuated display of a rectangular portion 51 or rectangular portions 52 corresponding to the period having the satisfying retention situation in the inter-step band 160B (or intra-step band 160A) corresponding to the inter-step range (or intra-step range) in which the satisfying retention situation has occurred. The inter-step band 160B (or intra-step band 160A) is the background of the polygonal lines. The portion subjected to the accentuated display is a portion of the background, and the position and range of the portion correspond to the period having the foregoing satisfying retention situation. Accordingly, it is easy to recognize the relationships between the retention situations and the production situations for a relatively large number of products as the whole without impairing the visibility of the polygonal lines showing the production situations of the products.

As the mode of the “accentuated display”, any of various adoptable modes (e.g., changing of a line width, changing of a color, changing of a density, changing of a pattern, blinking, and displaying of a pop-up message) can be adopted.

The display mode of each of the inter-step bands 160B may be the same as the display mode of each of the intra-step bands 160A, but is different from the display mode of each of the intra-step bands 160A in the present embodiment. This allows the user to easily discriminate the regions corresponding to the intra-step ranges from the regions corresponding to the inter-stage ranges.

Also, in the present embodiment, the “retention situation satisfying a predetermined requirement” is a situation in which the retention number is equal to or larger than a first threshold or the retention number is less than a second threshold smaller than the first threshold, in the inter-step range (and/or in the intra-step range). This allows the inter-step range (and/or intra-step range) in which an excess situation having a relatively large retention number has occurred or the inter-step range (and/or intra-step range) in which an over-reduction situation having a relatively small retention number has occurred to be recognized from the diagram chart. Note that, e.g., the “excess situation” includes a warning retention situation in which the retention number is equal to or larger than a warning threshold and less than an abnormal threshold (the warning threshold is smaller than the abnormal threshold) and an abnormal retention situation in which the retention number is equal to or larger than the abnormal threshold. Each of the warning threshold and the abnormal threshold is an example of the first threshold. In addition, each of the excess situation and the over-reduction situation may be at multiple levels. As the level of the excess situation or the over-reduction situation is higher, the level of the accentuated display may be higher. For example, the level of the accentuated display of each of the abnormal rectangular portions 52 as the rectangular portions corresponding to the abnormal retention situation (rectangular regions in the band 160) is higher than the level of the accentuated display of the warning rectangular portion 51 as the rectangular portion corresponding to the warning retention situation (e.g., each of the abnormal rectangular portions 52 is displayed in a color more vivid or darker than the color of the warning rectangular portion 51).

In the present embodiment, with respect to at least one inter-step range (and/or at least one intra-step range), at least one of the first threshold (threshold for the excess situation) and the second threshold (threshold for the over-reduction situation) is a value depending on the inter-step range and/or the intra-step range. When the first threshold (threshold for the excess situation) is taken as an example, at least one of the warning threshold and the abnormal threshold differs from one inter-step range (and/or one intra-step range) to another. Consequently, the retention situation to be subjected to the accentuated display is appropriate with respect to at least one inter-step range (and/or at least one intra-step range).

In the present embodiment, the heights of the respective inter-step bands 160B and the heights of the respective intra-step bands 160A (lengths along the step axis) are uniform. Accordingly, the degree of influence given by the retention period (period from the ending time to the starting time) of each product in each inter-step range on the inclination of the line segment and the degree of influence given by the retention period (period from the starting time to the ending time) of each product in each intra-step range on the inclination of the line segment are uniform. As a result, it is possible to recognize, from the inclination of each of the line segments, which product has a relatively long retention period in which inter-step or intra-step range.

On the diagram chart 170, each of the polygonal lines represents, for each product, the relationship between the step and the execution time (which is the starting time and the ending time in the present embodiment, as described above). When the flow of products becomes irregular due to a cause such as the occurrence of fluctuations in a processing period in a given step or the occurrence of product overtaking (such that a given product is removed in a given step and a product loaded later than the product flows ahead of the product), any of the blank regions on the diagram chart 170 may be unnaturally increased or reduced in size. When the irregular flow occurs frequently, numerous such blank regions are observed on the diagram chart 170.

In production management, management of a situation between steps and a situation between products in the same step is an important management item. It can be considered that at least one of the shape and size of the blank region depends on such a situation.

However, it is difficult to precisely determine, by visual inspection, whether or not each of the blank regions is a noteworthy blank region (e.g., blank region associated with any abnormal situation). For example, even when the blank region has a large size, the blank region is not necessarily the blank region associated with an abnormal situation. Conversely, even when the blank region has a small size, the blank region is not necessarily a blank region associated with a normal situation.

In addition to such a problem associated with the size of the blank region, when numerous blank regions are present on the diagram chart 170, it is significantly difficult to examine, by visual recognition, all the blank regions for whether or not the blank regions are associated with abnormal situations. Specifically, since, e.g., products are successively loaded into the production line in a short period of time as described above, there are numerous management targets. When it is attempted to holistically manage the production situation, the polygonal lines are densely arranged on the display screen of the diagram chart 170. Consequently, there are numerous blank regions which are so small that it is difficult to visually recognize the blank regions, and noteworthy blank regions may be missed.

Accordingly, in the present embodiment, each of the blank regions on the diagram chart 170 may be adopted as one of the display objects. In other words, in addition to objects actually drawn such as polygonal lines, the region between the polygonal lines in a display area, such as a plot area, may also be adopted as one of the display objects. In short, the concept of the display object may be expanded. Specifically, the support program 150 may specify, among the plurality of blank regions on the diagram chart 170, the blank region satisfying the one or more requirements associated with the one or more attentional perspectives and perform the accentuated display of the specified blank region. Thus, the noteworthy blank region may automatically be recommended. The user is allowed to preferentially examine first the details (e.g., the details of a product) of a situation (e.g., the step or time belonging to the blank region) associated with the recommended blank region (subjected to the accentuated display). As a result, it can be expected to further reduce a burden on production management for recognizing an abnormality occurring in the production process in the production line and reliably preventing shipment of defective products.

Note that the support program 150 can set the accentuation level (e.g., color shade) of the blank region as an accentuated display target to an accentuation level in accordance with at least one of items (A) to (C) shown below which are:

(A) the degree of importance of at least one of the one or more attentional perspectives on the basis of which the blank region is determined to be the accentuated display target;

(B) the number of the attentional perspectives on the basis of which the blank region is determined to be the accentuated display target; and

(C) the value (e.g., the area of the blank region or a measurement value obtained by measuring the interval between the times belonging to the blank region) obtained for the blank region on the basis of the attentional perspectives.

As a result, when the plurality of blank regions are subjected to the accentuated display, the user can promptly determine the blank region, the situation of which should preferentially be recognized first. Note that (A) and (B) are effective when, e.g., the blank region as the accentuated display target is determined on the basis of the plurality attentional perspectives (i.e., when the same blank region may be determined to be the accentuated display target on the basis of each of the plurality of attentional perspectives). On the other hand, (C) is effective when the value calculated for the blank regions on the basis of the same attentional perspective differs from one blank region to another.

In addition, the user is allowed to specify at least one of the attentional perspectives or the degree of importance thereof. This allows the noteworthy blank region to be recommended on the basis of the perspective intended by the user.

As the attentional perspective, various perspectives can be adopted. For example, as the attentional perspective that can be specified, at least one of perspectives shown below can be adopted, which are:
the size of an interval (a work suspension period in the same step (e.g., the difference between the ending time of the product y and the ending time of the product (y+1)));
the area of a blank region;
a target step;
the type of a facility (machine) associated with a production line;
the type of target work;
the occurrence of overtaking;
the relationship with the occurrence of overtaking (e.g., whether or not overtaking has occurred immediately before (a given time before) or immediately after (a given time after));
the occurrence of a defective product;
the relationship with the occurrence of a defective product (e.g., whether or not a defective product has occurred immediately before or immediately after);
the type of the occurred defect;
the degree of overtaking (e.g., the number of the overtaken products);
the magnitude of a specific measurement value;
the changing tendency of a specific measurement value;
the type or content of a facility alert;
a worker;
the type or content of data in a work record file (records of events (e.g., alert or work) occurred in a production site) associated with the occurrence time of at least one of a defective product, facility trouble, and a facility alert;
elimination of a display object associated with plan suspension from the accentuated display targets;
a maximum standby period; and
the point of origin of a blank region.

There may be at least one of an attentional perspective for which it is fixedly set in advance that selection of whether or not the attentional perspective is specified by a user is impossible and an attentional perspective for which selection of whether or not the attentional perspective is specified by a user is possible.

The following will describe the present embodiment in detail.

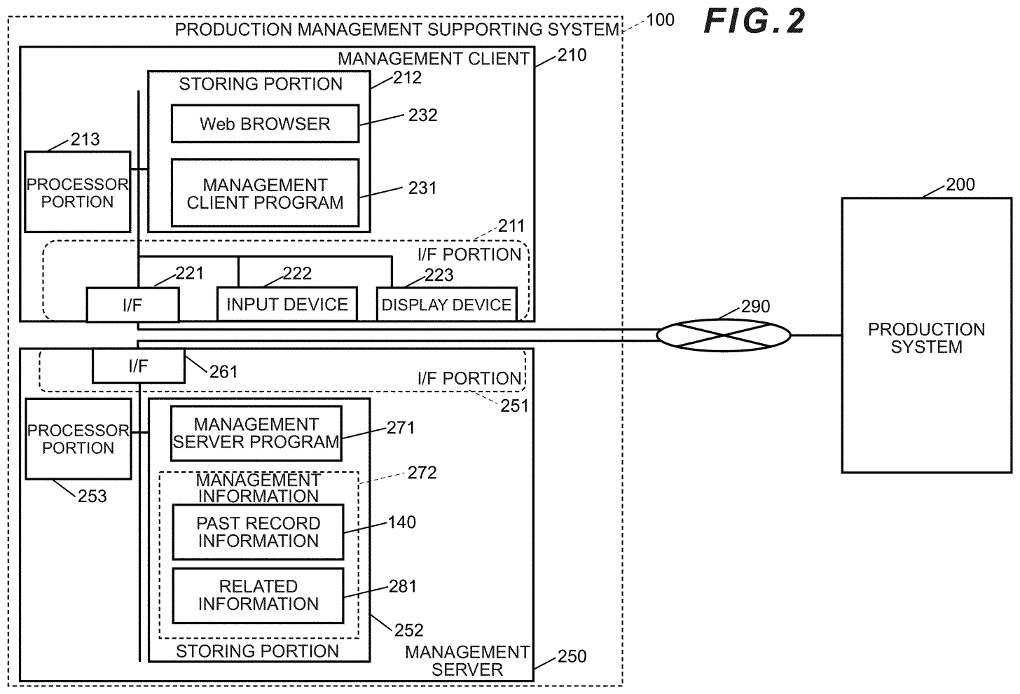

FIG. 2 shows a configuration of the production management supporting system 100.

The production management supporting system 100 includes a management server 250 and one or more management clients 210 coupled to the management server 250. To the management server 250, each of the management clients 210 and a production system 200 is coupled via a communication network (e.g., a local area network (LAN), a wide area network (WAN), or the Internet) 290.

The production system 200 is a system (e.g., factory) including a production line and includes apparatuses such as, e.g., a plurality of apparatuses for a plurality of steps in the production line, a plurality of sensors which regularly perform measurement for a plurality of measurement items with regard to the plurality of steps, and a server which stores a plurality of measurement values regularly obtained using the plurality of sensors and transmits the plurality of measurement values to the management server 250. From the production system 200, information (raw data such as, e.g., production dynamic state data, facility data, and quality measurement data) is regularly or irregularly transmitted to the management server 250 and stored in the management server 250. For example, the information includes, for each product, a product ID, and the starting time and the ending time of each step.

The management client 210 has an I/F portion 211, a storing portion 212, and a processor portion 213 coupled to the I/F portion 211 and the storing portion 212.

The I/F portion 211 includes an I/F (communication interface device coupled to the communication network 290) 221, an input device (e.g., pointing device or keyboard) 222, and a display device (device having a physical screen which displays information) 223. A touch screen integrally including the input device 222 and the display device 223 may also be adopted.

The storing portion 212 stores a computer program executed by the processor portion 213 and information used by the processor portion 213. Specifically, for example, the storing portion 212 stores a management client program 231 and a Web browser 232. The management client program 231 communicates with the management server 250 and displays information such as the diagram chart 170 described above via the Web browser 232.

The management server 250 has an I/F portion 251, a storing portion 252, and a processor portion 253 coupled to the I/F portion 251 and the storing portion 252.

The I/F portion 251 includes an I/F (communication interface device coupled to the communication network 290) 261.

The storing portion 252 stores a computer program executed by the processor portion 253 and information used by the processor portion 253. Specifically, for example, the storing portion 252 stores a management server program 271 and management information 272. The management server program 271 communicates with the management client program 231. The management information 272 includes the past record information 140 and related information 281. The past record information 140 is information related to a past record such as the starting time and the ending time of each of the steps for each product loaded in the production line. The past record information 140 may include the raw data mentioned above. The related information 281 is information related to the past record. A portion of the related information 281 may also be data generated on the basis of the result of analyzing the past record information 140. The related information 281 includes a threshold (e.g., threshold in each inter-step range (and/or in each intra-step range)) to be compared to the retention number in, e.g., the inter-step range (and/or intra-step range).

Through a cooperative process performed by the management server program 271, the management client program 231, and the Web browser 232, the display of a screen (typically graphical user interface (GUI)) including the diagram chart 170 is implemented.

The relationships between the components shown in FIG. 2 and the components shown in FIG. 1 are, e.g., as follows. Specifically, of the I/F portions 211 and 251, at least the I/F portion 251 corresponds to the I/F portion 110. Of the storing portions 212 and 252, at least the storing portion 252 corresponds to the storing portion 120. Of the processor portions 213 and 253, at least the processor portion 253 corresponds to the processor portion 130. Of the management server program 271, the management client program 231, and the Web browser 232, at least the management server program 271 corresponds to the support program 150.

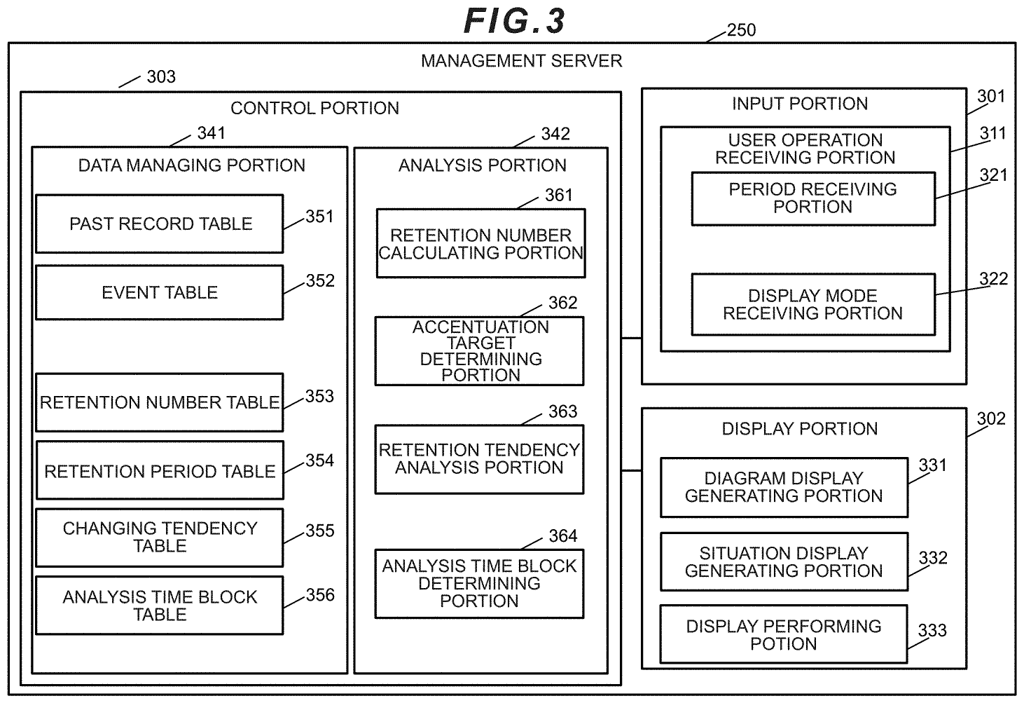

FIG. 3 shows an example of the functions implemented in the management server 250.

The management server program 271 is executed by the processor portion 253 to allow the illustrated functions, i.e., an input portion 301, a display portion 302, and a control portion 303 to be implemented. In other words, the management server program 271 has the input portion 301, the display portion 302, and the control portion 303.

The input portion 301 is the function for receiving information. The input portion 301 includes a user operation receiving portion 311. The user operation receiving portion 311 is a function for receiving a user operation (operation performed on the screen by the user using the input device). The user operation receiving portion 311 includes a period receiving portion 321 and a display mode receiving portion 322. The period receiving portion 321 is a function for receiving a specification of the display target period. The display mode receiving portion 322 is a function for receiving a specification of which one of a plurality of display modes described later is to be achieved.

The display portion 302 is the function for displaying information. The display portion 302 includes a diagram display generating portion 331, a situation display generating portion 332, and a display performing portion 333. The diagram display generating portion 331 is a function for generating the display of the diagram chart (e.g., drawing the diagram chart on a memory portion). The situation display generating portion 332 is a function for generating the display of the retention situation or the like (e.g., generating (drawing) the accentuated display of the rectangular portion corresponding to the retention situation satisfying the predetermined requirement). The display performing portion 333 is a function for performing the display of the diagram chart (and the retention situation or the like) the display of which is generated.

The control portion 303 is a function for control. The control portion 303 includes a data managing portion 341 and an analysis portion 342.

The data managing portion 341 acquires the past record data of a product to update a past record table 351 on the basis of the past record data and acquires related data to update an event table 352 on the basis of the related data. The data managing portion 341 also manages tables such as the past record table 351, the event table 352, a retention number table 353, a retention period table 354, a changing tendency table 355, and an analysis time block table 356.

Note that the “past record data” is data showing the past record of production and including, e.g., a product ID (e.g., product number), a step ID (e.g., step number), a time (e.g., the collection time of the data or the starting time and the ending time of the step), and a status (showing that, e.g., a process is currently performed in the step or the step was ended). For example, the data managing portion 341 regularly or irregularly collects the past record data from the line production system 200 and updates the past record table 351 on the basis of the collected past record data. The past record table 351 is at least a portion of the past record information 140.

On the other hand, the “related data” is data related to the past record of production (e.g., data other than the past record data, which is data of a predetermined type). For example, the data managing portion 341 regularly or irregularly collects event data as an example of the related data from the line production system 200 and updates the event table 352 on the basis of the collected event data.

The retention number table 353, the retention period table 354, the changing tendency table 355, and the analysis time block table 356 are dynamically generated on the basis of the past record table 351 and the event table 352. Each of the event table 352, the retention number table 353, the retention period table 354, the changing tendency table 355, and the analysis time block table 356 is at least a portion of the related information 281.

The analysis portion 345 is a function for analysis. The analysis portion 345 includes a retention number calculating portion 361, an accentuation target determining portion 362, a retention tendency analysis portion 363, and an analysis time block determining portion 364. The retention number calculating portion 361 calculates the retention number. The accentuation target determining portion 362 determines the presence or absence of an accentuated display target. When there is an accentuated display target, the accentuation target determining portion 362 causes the display portion 302 to draw and perform the accentuated display of the target. The retention tendency analysis portion 363 analyzes the changing tendency of retention. The analysis time block determining portion 364 determines an analysis time block as the time block (e.g., time window) as a range subjected to analysis.

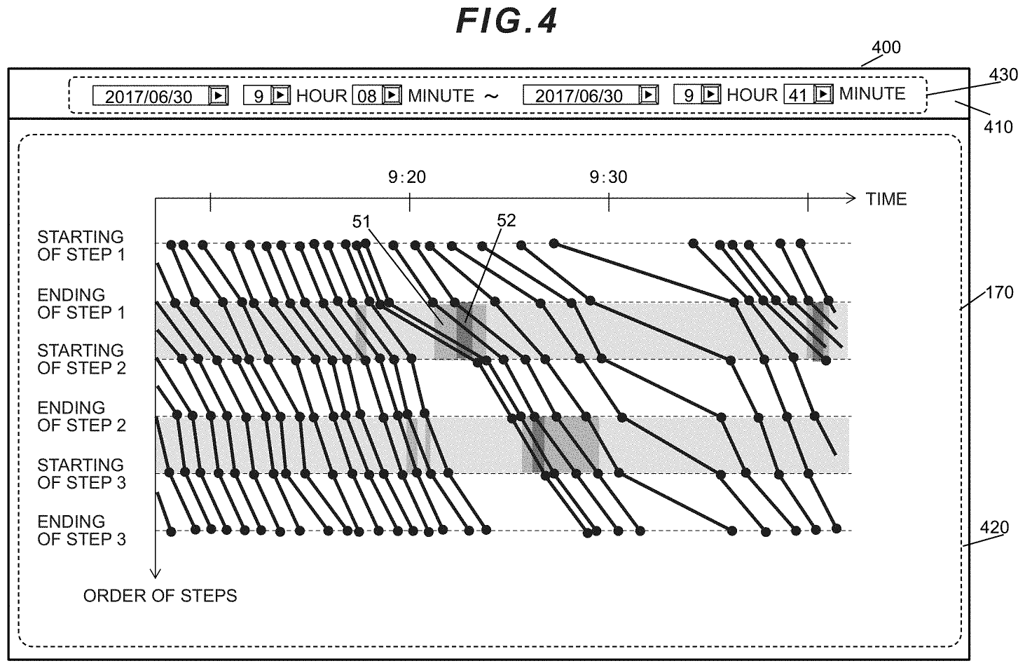

FIG. 4 shows an example of a diagram chart screen.

A diagram chart screen 400 is, e.g., a graphical user interface (GUI) and has a user interface (UI) area 410 and a graph area 420.

On the UI area 410, a period specification UI 430 is displayed. The period specification UI 430 is the UI (e.g., GUI component) that receives a specification of the display target period. The “display target period” is the period of the production situation determined to be a display target among the managed production situations. In the present embodiment, as shown in the drawing, the display target period is specified by a pair of a starting time and an ending time. However, the display target period may also be specified by another method, e.g., a pair of a reference time (e.g., starting time) and a length or by scrolling a display range (scrolling along the direction of the axis corresponding to time).

The graph area 420 displays the diagram chart 170 showing the production situation during the display target period specified using the period specification UI 430. The chart 170 is a two-dimensional graph in which the abscissa axis is the time axis, the ordinate axis is the step axis, and one polygonal line corresponds to one product.

Along the step axis, the steps are alternately arranged in the order in which the steps are present in the production line. Specifically, the starting axes 159S of the steps and the ending axes 159E thereof are alternately arranged in the sequential order of the steps. In other words, the intra-step bands 160A and the inter-step bands 160B are alternately arranged in the sequential order of the steps. For each product belonging to the display target period, respective points corresponding to the starting times and the ending times of a plurality of steps through which the product has passed are plotted on the starting axes 159S and the ending axes 159E. By connecting all the points with a line for each product, the polygonal line is formed, the result of which is displayed as the diagram chart 170.

On the diagram chart 170 shown in FIG. 4, at the time when the diagram chart 170 is displayed, the rectangular portions (the warning rectangular portion 51 and the abnormal rectangular portions 52 each mentioned above) each corresponding to the retention situation in which the retention number is equal to or larger than the threshold are already subjected to the accentuated display. However, whether or not such rectangular portions each corresponding to the retention situation are to be subjected to the accentuated display may also be settable by a user operation.

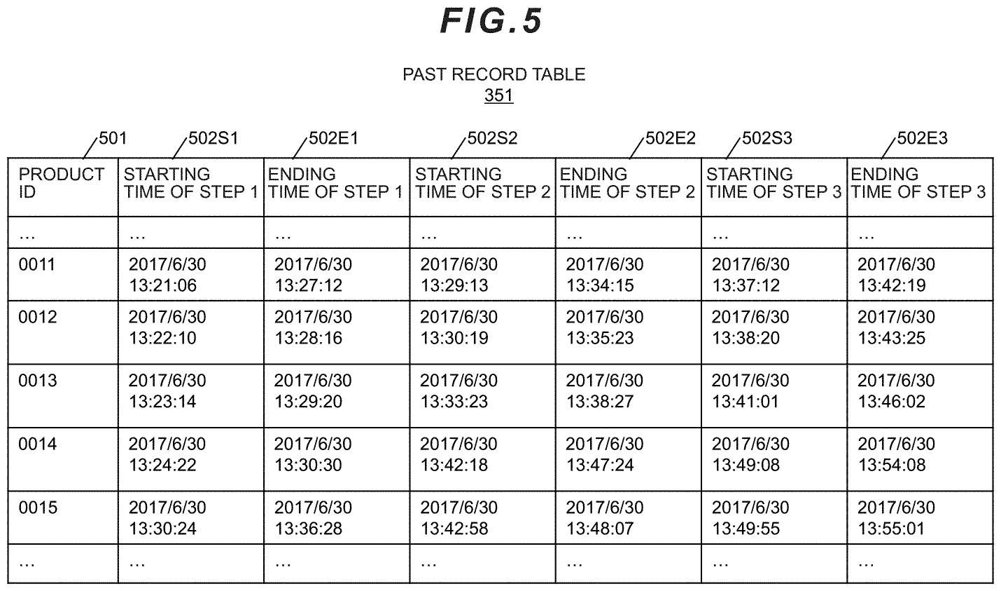

FIG. 5 shows the past record table 351.

The past record table 351 is prepared for, e.g., each production line. The past record table 351 holds information related to the past record of production. Specifically, the past record table 351 shows a history of products flowing in the production line, and the starting times and the ending times of the steps included in the production line. More specifically, the past record table 351 has, e.g., records for individual products on a one-to-one basis. Each of the records stores information such as a product ID 501, starting times 502S1 to 502S3 of steps 1 to 3 included in the production line, and ending times 502E1 to 502E3 thereof.

Also, in the present embodiment, a time is represented in a year/month/day/hour/minute/second unit, but the unit of a time may be rougher or finer than the unit used in the present embodiment. A time may also be represented in a different unit.

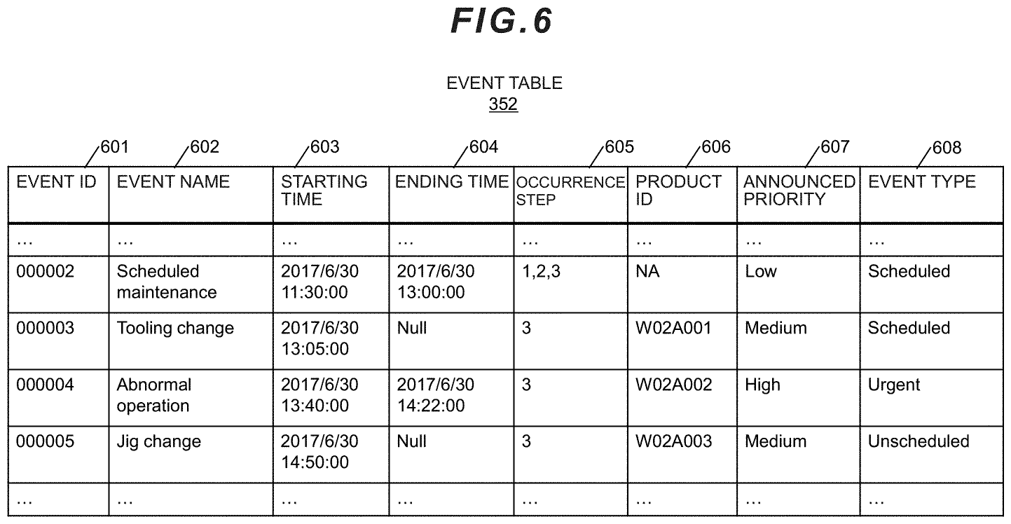

FIG. 6 shows the event table 352.

The event table 352 holds information related to the events occurred in relation to the production line. Specifically, the event table 352 has, e.g., records for the individual events on a one-to-one basis. Each of the records stores information such as an event ID 601, an event name 602, a starting time 603, an ending time 604, an occurrence step 605, a product ID 606, an announcement priority 607, and an event type 608. One record corresponds to the event data. The event data is an example of the related data.

The event ID 601 shows the ID of the event. The event name 602 shows the name of the event. The starting time 603 shows the time at which the event is started (has occurred). The ending time 604 shows the time at which the event is ended. “Null” means that the ending time of the event is undetermined. The occurrence step 605 shows the step in which the event has occurred. The product ID 606 shows the ID of the product associated with the event. The announcement priority 607 shows the priority of the announcement (display) of the event. The event type 608 shows the event type to which the event belongs. “Scheduled” means a scheduled event. “Unscheduled” means an unscheduled event. “Urgent” means the highly urgent event (e.g., abnormal event) among unscheduled events.

According to the example in FIG. 6, the announcement priority is at “Low”, “Medium”, and “High” three levels, but the number of the levels may be smaller or larger than three. The level of the announcement priority of each of the events may also depend on the event type.

In the present embodiment, for example, there are display modes (m1) to (m5) shown below. In the present embodiment, to achieve one or more of the display modes (m2) to (m5), the achievement of the display mode (m1) is mandatory. However, instead of doing so, it may also be possible to achieve one or more of the display modes (m2) to (m5) without achieving the display mode (m1).

Display mode (m1): display of trouble retention situation
Display mode (m2): display of trouble high frequency step
Display mode (m3): display of affected interval
Display mode (m4): display of event
Display mode (m5): display of changing tendency of retention

The following will describe each of the display modes. It is assumed that, in the following description, for ease of explanation, the retention number is calculated for each inter-step range and for each intra-step range, while the warning threshold and the abnormal threshold are set for each inter-step range, but are not set for each intra-step range. In other words, it is assumed that, in the following description, the accentuated display associated with the warning retention situation and the abnormal retention situation may be performed for the inter-step range, but may not be performed for the intra-step range. Note that, in the present invention, the accentuated display of the trouble retention situation such as the warning retention situation or the abnormal retention situation is not limited to that for the inter-step range. Instead of or in addition to the accentuated display of the trouble retention situation for the inter-step range, the accentuated display of the trouble retention situation for the intra-step range may also be performed.

<Display Mode (m1): Display of Trouble Retention Situation>

“Display of the trouble retention situation” is displaying a retention situation such as the warning retention situation or the abnormal situation, if any.

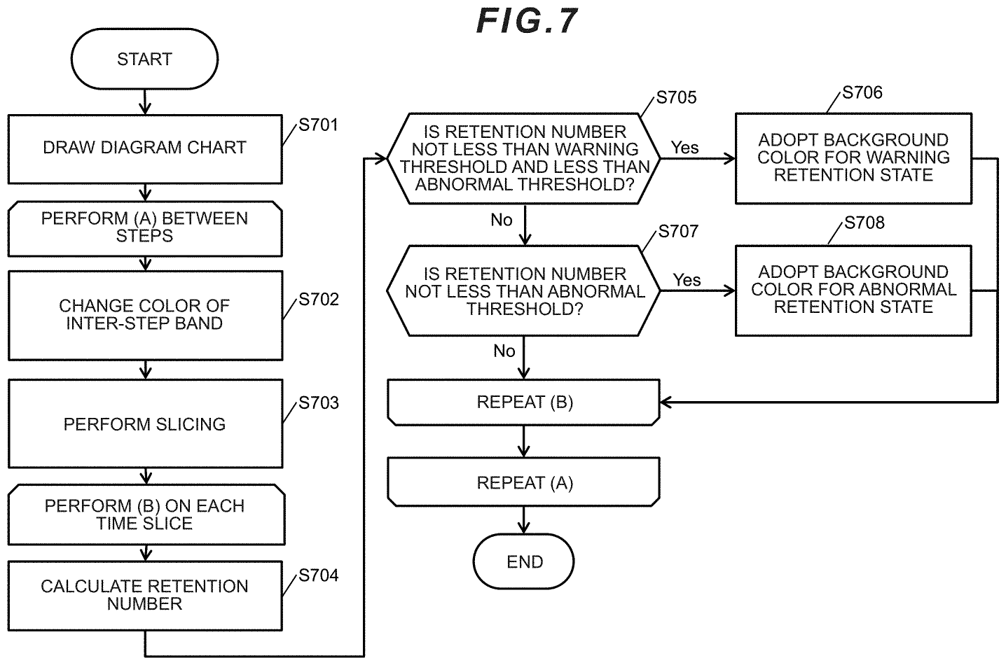

FIG. 7 shows the flow of a display control process related to the display mode (m1).

The management server program 271 draws the diagram chart during the display target period on the memory portion on the basis of the past record table 351 (S701). For example, the time axis and the step axis are drawn and, for each step, the starting axis 159S and the ending axis 159E are drawn. As a result, the intra-step bands 160A and the inter-step bands 160B are alternately arranged along a direction parallel with the step axis. Then, for each product belonging to the display target period, the point corresponding to the starting time of each step for the product is plotted on the starting axis, the point corresponding to the ending time of each step for the product is plotted on the ending axis, and the point on the starting axis and the point on the ending axis are connected. Consequently, the polygonal line for each product is drawn.

With respect to each inter-step range and each intra-step range, S702 to S708 are performed (loop (A)). In the following, one inter-step range and one intra-step range are taken as examples (which are a “target inter-step range” and a “target intra-step range” in the description of FIG. 7).

The management server program 271 displays the inter-step band 160B corresponding to the target inter-step range in a display mode (e.g., color) different from the display mode in which each of the intra-step bands 160A is displayed (S702).

The management server program 271 slices the display target period on a per unit time basis (e.g., every one minute), starting from the starting time (S703). In other words, a time corresponding to every unit time between the starting time of the display target period to the ending time thereof is determined to be a time as a target of retention number calculation. The individual periods obtained by the slicing are hereinafter referred to as “time slices”. A time belonging to each of the time slices (e.g., the starting time of each of the time slices) is an example of the time as the target of retention number calculation. Note that the time slices may also be determined by another method, such as by random determination.

With respect to each of the time slices, S704 to S708 are performed (loop (B)). In the following, one time slice is taken as an example (which is a “target time slice” in the description of FIG. 7).

The management server program 271 calculates, for the target time slice, the respective retention numbers in the target inter-step range and the target intra-step range (S704). The retention numbers calculated for the target inter-step range and the target intra-step range in S704 correspond to the number of products present in the target time slice and is recorded in the retention number table 353.

The management server program 271 determines, for the target time slice, whether or not the retention number in the target inter-step range is equal to or larger than the warning threshold in the target inter-step range and less than the abnormal threshold in the target inter-step range on the basis of the retention number table 353 (S705). When the result of the determination in S705 is true (Yes in S705), the management server program 271 changes the display mode of the portion of the inter-step band 160B as the target inter-step range which corresponds to the target time slice to a display mode corresponding to the warning retention situation (S706).

When the result of the determination in S705 is false (No in S705), the management server program 271 determines, for the target time slice, whether nor not the retention number in the target inter-step range is equal to or larger than the abnormal threshold in the target inter-step range on the basis of the retention number table 353 (S707). When the result of the determination in S707 is true (Yes in S707), the management server program 271 changes the display mode of the portion of the inter-step band 160B as the target inter-step range which corresponds to the target time slice to a display mode corresponding to the abnormal retention situation (S708).

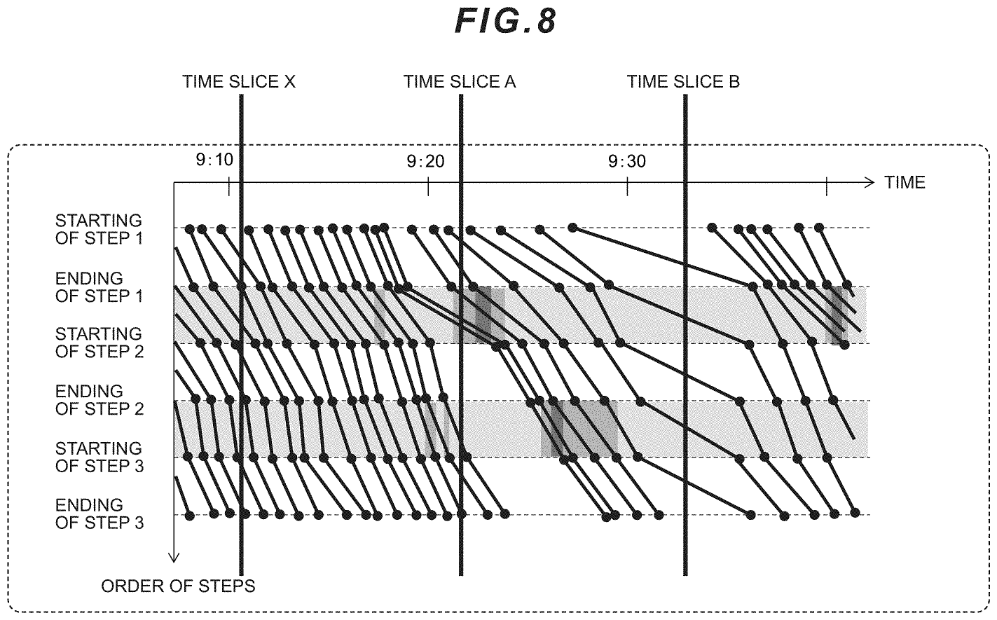

FIG. 8 shows the outline of an example of retention number calculation.

It is assumed that, in FIG. 8, the relationships between each inter-step range and the warning threshold and the abnormal threshold are as follows.

Inter-step range 1-2: warning threshold is “3” and abnormal threshold is “4” Inter-step range 2-3: warning threshold is “2” and abnormal threshold is “3”

In FIG. 8, three time slices X, A, and B are shown by way of example. These times slices X, A, and B are as follows.

Specifically, the time slice X is as follows.
The retention number in the inter-step range 1-2 is “1”. This is because the number of the line segments crossing the time slice X in the inter-step range 1-2 is “1”. The retention number “1” is smaller than each of the warning threshold and the abnormal threshold in the inter-step range 1-2. Accordingly, the portion of the inter-step band 160B1 which corresponds to the time slice X is not determined to be the accentuated display target.
The retention number in the inter-step range 2-3 is “0”. Accordingly, the portion of the inter-step band 160B2 which corresponds to the time slice X is not determined to be the accentuated display target.

The time slice A is as follows.
The retention number in the inter-step range 1-2 is “3”. This is because the number of the line segments crossing the time slice A in the inter-step range 1-2 is “3”. The retention number “3” is equal to or larger than the warning threshold in the inter-step range 1-2, but is less than the abnormal threshold in the inter-step range 1-2. Accordingly, the portion of the inter-step band 160B1 which corresponds to the time slice A is determined to be the accentuated display target corresponding to the warning retention situation.
The retention number in the inter-step range 2-3 is “1”. The retention number “1” is smaller than each of the warning threshold and the abnormal threshold in the inter-step range 2-3. Accordingly, the portion of the inter-step band 160B2 which corresponds to the time slice A is not determined to be the accentuated display target.

The time slice B is as follows.
The retention number in the inter-step range 1-2 is “1”. Accordingly, the portion of the inter-step band 160B1 which corresponds to the time slice B is not determined to be the accentuated display target.
The retention number in the inter-step range 2-3 is also “1”. Accordingly, the portion of the inter-step band 160B2 which corresponds to the time slice B is not determined to be the accentuated display target.

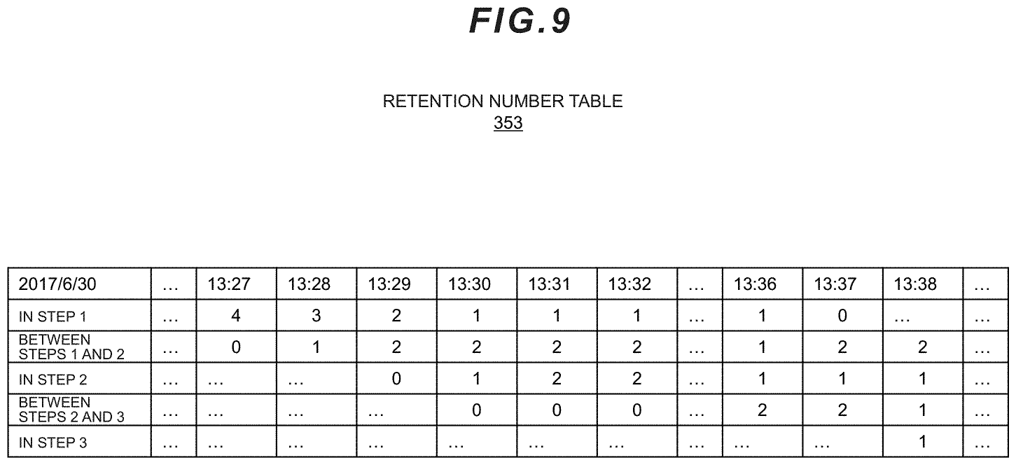

FIG. 9 sows the retention number table 353.

The retention number table 353 holds, for each time slice, the retention numbers calculated on a per inter-step and intra-step range basis. Specifically, for example, the retention number table 353 has records for the individual inter-step ranges and the individual intra-step ranges on a one-to-one basis. In each record, the retention number calculated for the intra-step range or inter-step range corresponding to the record is recorded on a per time slice basis.

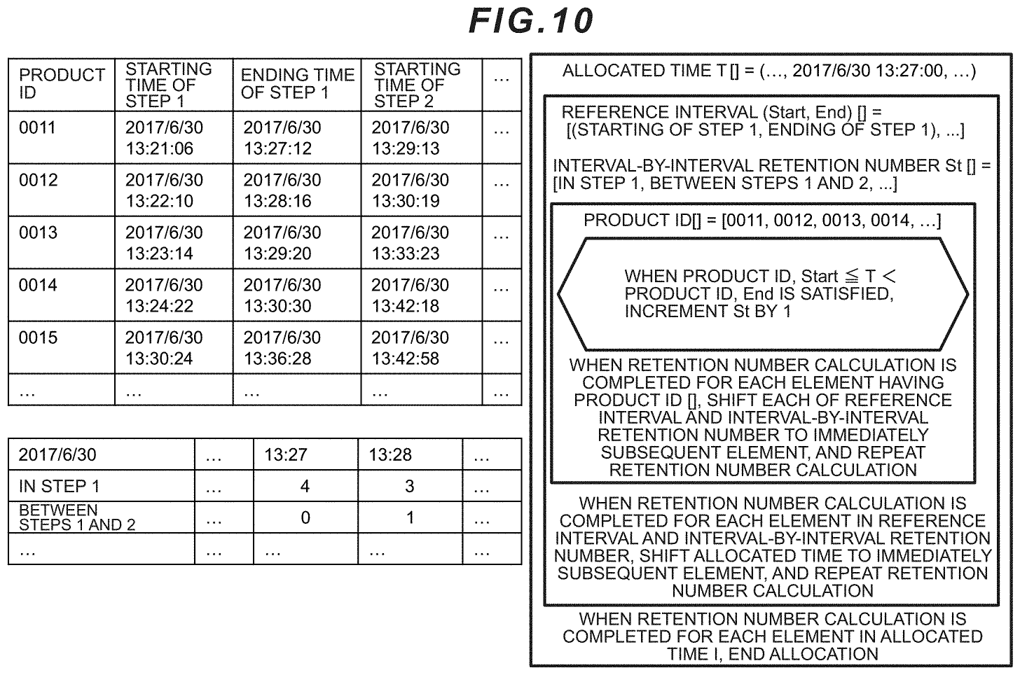

FIG. 10 is an illustrative view of an example of retention number calculation.

In the retention number calculation, the following variables are used. Of the following variables, a reference interval (Start, End) and an interval-by-interval retention number St are provided on a per time slice basis. A product ID is provided on a per reference interval basis. The variables include:
an allocated time T as a variable to which a time (e.g., starting time) in the time slice is set as a value;
the reference interval (Start, End) as variables to which the reference interval is set as values, of which “Start” is the variable to which the definition of the starting of the reference interval is set as a value (specifically, a variable to which the inter-step range or intra-step range in which the reference interval is started is set as a variable) and “End” is a value to which the definition of the ending of the reference interval is set as a value (specifically, a variable to which the inter-step range or intra-step range in which the reference interval is ended is set as a variable);
the interval-by-interval retention number St as the count value of the products in each reference interval; and
the product ID.

The details of the retention number calculation (S704) is as follows. In the following, one reference interval (inter-step range or intra-step range) and one time slice are taken as examples (which are a “target reference interval” and a “target time slice” in the description of FIG. 10).
The management server program 271 sets a time (e.g., stating time) in the target time slice to the allocated time T.
Next, the management server program 271 respectively sets the starting and ending of the target reference interval to Start and End.
Finally, “when product ID, Start T<product ID, End is satisfied, the management server program 271 increments the interval-by-interval retention number St by 1” on a per product basis.

For example, when allocated time T=2017/6/30 13:27:00 and reference interval (Start, End)=(starting of step 1, ending of step 1) are assumed to be satisfied, according to the example in FIG. 10, “product ID, Start T<product ID, End” is satisfied with respect to the four products (product IDs “0011” to “0014”). Accordingly, “4” is allocated to the retention number, and the retention number “4” is recorded in the corresponding cell of the retention number table 353 (the cell corresponding to in step 1 and 2017/6/30 13:27:00).

<Display Mode (m2): Display of Trouble High Frequency Step>

The display mode (m2) can be adopted when there are two or more inter-step ranges (the inter-step range may also be one when the accentuated display target of the trouble retention situation is also applicable to the intra-step range). The “display of the trouble high frequency step” is performing the accentuated display of the inter-step range in which the frequency of the retention situation satisfying the predetermined requirement is relatively high. The “retention situation satisfying the predetermined requirement” may appropriately be, e.g., the excess situation or over-reduction situation at a level worse than a given level (e.g., the worst) among the excess situations or over-reduction situations at multiple levels.

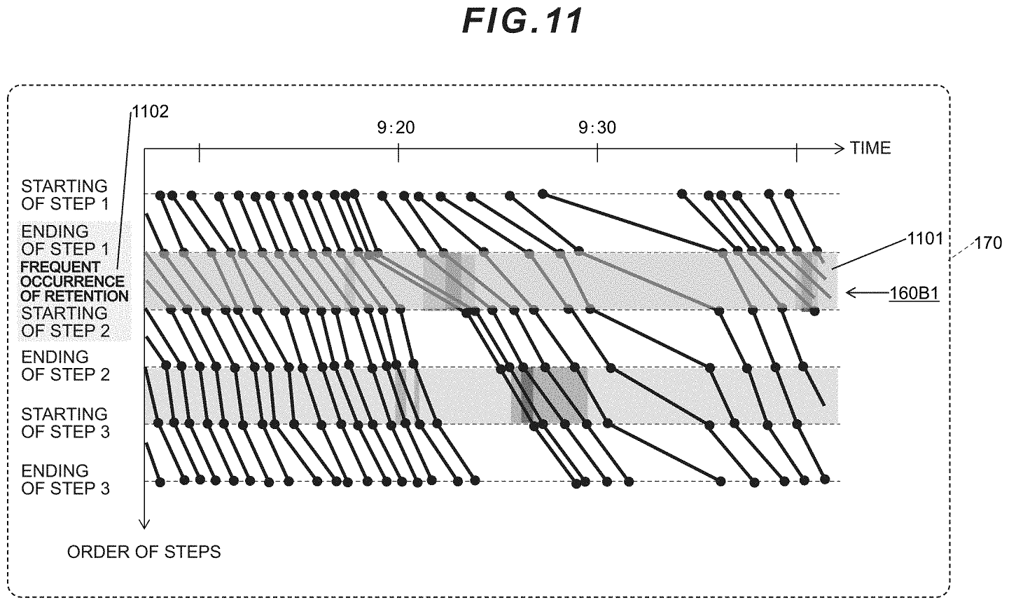

FIG. 11 shows an example of the display of the trouble high frequency step.

The display shown by way of example in FIG. 11 may be performed when the achievement of the present display mode (m2) is specified by the user or settings which allow the display to be performed may also be made in advance. According to the example in FIG. 11, “the retention situation satisfying the predetermined requirement” is the abnormal retention situation. The “frequency” is at least one of the number of occurrences of the abnormal retention situation and a cumulative period. The “number of occurrences” is a count value when the abnormal retention situation from the start thereof to the end thereof is counted as one set (once). The “cumulative period” is a total value of one or more periods individually corresponding to one or more abnormal retention situations. The period of each of the abnormal retention situations is the period from the starting of the abnormal retention situation to the ending thereof.

The management server program 271 may allocate, for each time slice, the retention number on a per inter-step range basis and determine whether or not the retention number is equal to or larger than the abnormal threshold, by using a method such as that shown in FIG. 7. When there is the inter-step range for which the result of the determination is true for each time slice, the period corresponding to the time slice is the period having the abnormal retention situation with respect to the inter-step range.

The management server program 271 calculates, for each inter-step range, the frequency of the abnormal retention situation (which is at least one of the number of occurrences of the abnormal retention situation and the cumulative period). Then, the management server program 271 performs the accentuated display of the inter-step range having a calculated frequency which is relatively high (highest). According to the example in FIG. 11, the inter-step range having a relatively high frequency is the inter-step range 1-2, the accentuated display target is the inter-step band 160B1 corresponding to the inter-step range 1-2, and the mode of the accentuated display is the superimposition of a translucent band 1101 (an example of the display object) over the entire region of the inter-step band 160B1 and the display of a display object 1102 including the character string “FREQUENT OCCURRENCE OF RETENTION” subjected to the accentuated display over the region including the character string “ENDING OF STEP 1” and the character string “STARTING OF STEP 2”.

For example, when only the display mode (m1) is adopted as the display mode to be achieved, the display mode of the inter-step range in which the abnormal retention situation has occurred is the same irrespective of the frequency of the abnormal retention situation. Accordingly, for the user to recognize the frequency of the abnormal retention situation, the user needs to individually calculate the frequency on a per inter-step range basis by visual inspection. However, when the display target period is long, the time axis is compressed (the period corresponding to the same range on the time axis is elongated), and therefore numerous polygonal lines are densely arranged along a direction parallel with the time axis. As a result, it is difficult for the user to calculate the frequency by visual inspection.

According to the present display mode (m2), it is possible to intuitively (easily) recognize the inter-step range for which measures should preferentially be taken in the whole production line by visual inspection.

<Display Mode (m3): Display of Affected Interval>

The “display of affected interval” is displaying an interval in which productivity is presumably affected.

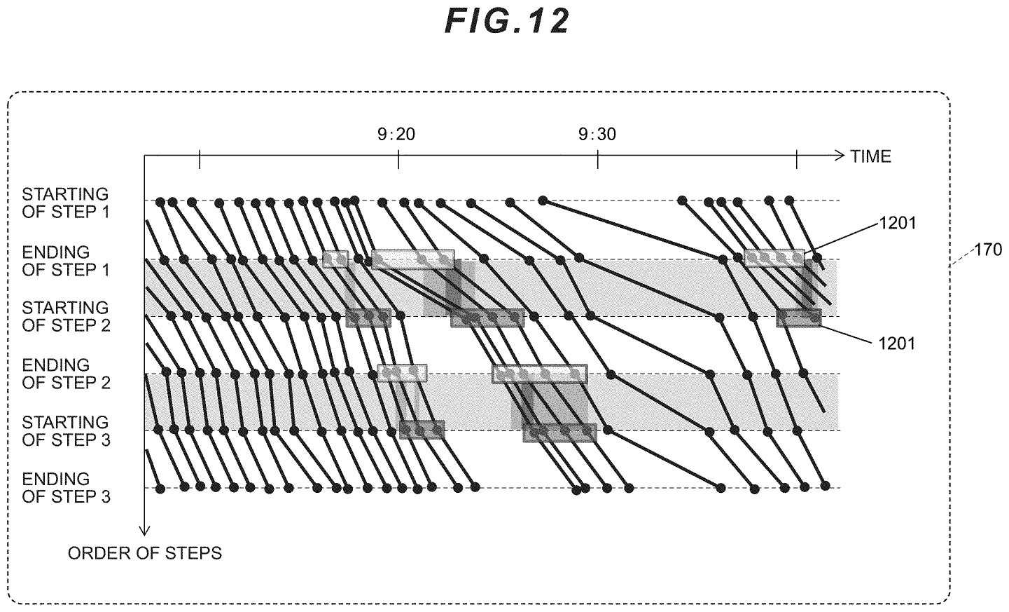

FIG. 12 shows an example of the display of the affected interval.

The display shown by way of example in FIG. 12 may be performed when the achievement of the present display mode (m3) is specified by the user or settings which allow the display to be performed may also be made in advance. The management server program 271 determines the presence or absence of a target time group for at least one step on the basis of the past record table 351.

For at least one step, the “target time group” mentioned herein is at least one of an ending time group and a starting time group.

For at least one step, the “ending time group” includes two or more ending times forming an ending time interval shorter than a starting time interval for the subsequent step and respectively corresponding to two or more consecutive products.

On the other hand, for at least one step, the “starting time group” includes two or more starting times forming a starting time interval longer than an ending time interval for the previous step and respectively corresponding to two or more consecutive products.

When there is such a target time group, it is presumed that, with respect to the inter-step range or intra-step range to which the target time group belongs, the retention period of a product having the starting time or the ending time belonging to the target time group tends to be long. As a result, it is presumed that the retention number in the inter-step range or intra-step range tends to be large. Accordingly, the target time group corresponds to the interval in which productivity is presumably affected.

As a result, when there is such a target time group, the management server program 271 displays an affected interval display object 1201 as the display object covering two or more points corresponding to the two or more times forming the target time group such that the affected interval display object 1201 overlaps the two or more points (or as the background of the two or more points). At that time, as shown by way of example in FIG. 12, the display mode of the affected interval display object 1201 may differ depending on whether the target time group is the ending time group or the starting time group.

Instead of or in addition to the display of the affected interval display object 1201, the management server program 271 may also perform the accentuated display of the two or more points respectively corresponding to the two or more times forming the target time group.

The presence or absence of the target time group is determined for at least one step, and the “at least one step” may be each of all the steps or may also be limited to the step included in the inter-step range or intra-step range to which the retention situation satisfying the predetermined requirement (e.g., at least one of the warning retention situation and the abnormal retention situation) belongs. It may also be possible that the presence or absence of the target time group is determined for the affected time block that is a time block including at least a portion of a period having the retention situation satisfying the predetermined requirement (e.g., at least one of the warning retention situation and the abnormal retention situation), and is not determined for the other time blocks. This can reduce a burden on the process for displaying the affected interval. Note that the “affected time block” may be at least a portion of the period having the retention situation satisfying the predetermined requirement or a period obtained by adding on a given period at the beginning and/or ending of at least the portion of the period.

<Display Mode (m4): Display of Event>

The “display of event” is displaying an event presumed to have at least partially caused the retention situation (e.g., at least one of the warning retention situation and the abnormal retention situation) satisfying the predetermined requirement or presumed to be at least partially affected by the satisfying retention situation.

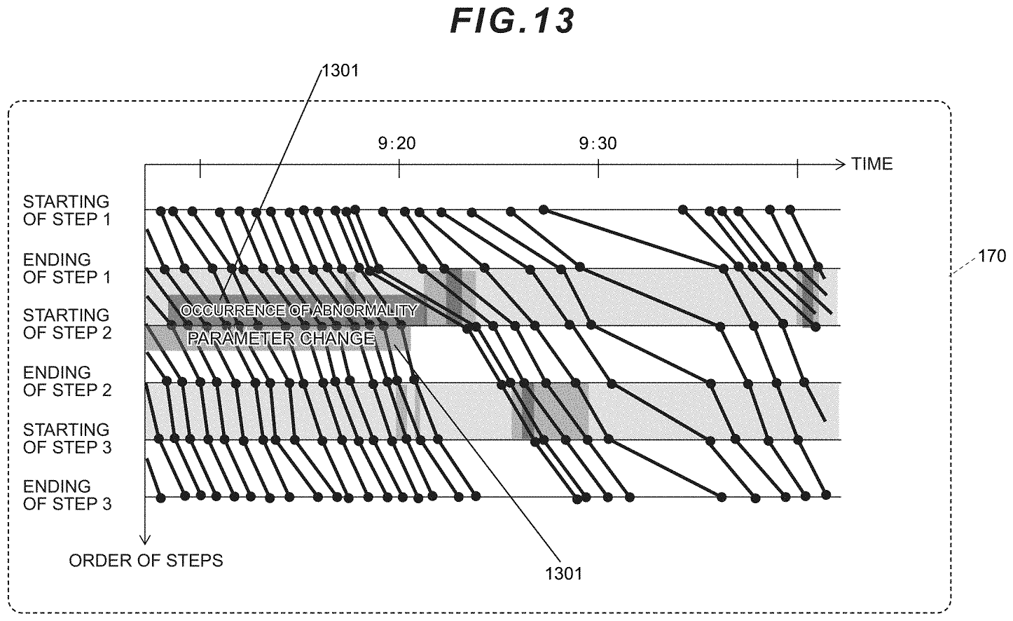

FIG. 13 shows an example of the display of an event.

The display shown by way of example in FIG. 13 may be performed when the achievement of the present display mode (m4) is specified by the user or settings which allow the display to be performed may also be made in advance. When there is the retention situation satisfying the predetermined requirement, the management server program 271 determines the presence or absence of an event satisfying requirements (c1) and (c2) shown below on the basis of the event table 352. Such an event corresponds to the event presumed to have at least partially caused the retention situation satisfying the predetermined requirement or presumed to be at least partially affected by the satisfying retention situation. Note that the “time block” in the requirement (c2) may be at least a portion of the period having the satisfying retention situation or a period obtained by adding on a given time at the beginning and/or ending of at least the portion of the period.

(c1) the occurrence step belongs to the inter-step and/or intra-step range in which the satisfying retention situation has occurred; and (c2) at least a portion of the event time block of the event belongs to a time block including at least a portion of a period having the satisfying retention situation.

When there is such an event, the management server program 271 superimposes an event display object 1301 (e.g., translucent band) as the display object having a length corresponding to the event time block of the event and parallel with the time axis, on the position on the diagram chart 170 corresponding to the step coincident with the occurrence step of the event and to the event time block of the event.

For example, in the display mode (m1) described above, the portion of the diagram chart 170 corresponding to the retention situation satisfying the predetermined requirement is subjected to the accentuated display. However, it may be difficult to recognize, only from the accentuated display of such a portion as corresponding to the retention situation, the factor that has caused the retention situation or the influence given by the retention situation.

Accordingly, in the present display mode (m4), the event display object 1301 corresponding to the event satisfying the requirements (c1) and (c2) shown above is displayed so as to overlap the diagram chart 170. This allows the user to browse through the diagram chart 170 and compare the event display object 1301 to the portion (e.g., the rectangular portion corresponding to the warning retention situation or the abnormal retention situation) of the diagram chart 170 which is subjected to the accentuated display. As a result, it can be expected to allow which event has caused which retention situation or which event has affected which retention situation to be presumed.

Note that, on the basis of FIG. 13, e.g., the following description may be given.

For each event, the event data showing the event has at least the event time block and the occurrence step. In the event data, the event time block includes, of the starting time and the ending time of the event, at least the occurrence time. When the ending time of the event time block is undetermined in the event data, the ending time may appropriately be a given time after the starting time. The given time may also differ from one event type to another.

As described above, the management server program 271 overlaps the event display object 1301 of the event on the “position corresponding to the step coincident with the occurrence step of the event and to the event time block of the event” on the diagram chart 170. When the “position corresponding to the step coincident with the occurrence step of the event and to the event time block of the event” refers to a position on the time axis, the position referred to may be a position corresponding to the starting time of the event time block for one end of the event display object 1301 and may be a position corresponding to the ending time of the event time block for the other end of the event display object 1301 (the ending time may be the ending time specified by the event data or may also be the ending time determined by the management server program 271). When the position refers to a position on the step axis, the position referred to may be a position corresponding to the occurrence step (specifically, e.g., at least one of the position coincident with the occurrence step, a position at a predetermined distance from the coincident position in a positive direction (downward direction in the example in FIG. 13), and a position at the predetermined distance from the coincident position in a negative direction (upward direction in the example in FIG. 13)).

When there are a plurality of the events each satisfying the requirements (c1) and (c2) shown above and the display positions of the plurality of events at least partly overlap, the event as the display target may be an event having a relatively high priority (e.g., having a highest priority) or having a relatively short event time block (e.g., having a shortest event time block). The “plurality of events” mentioned herein are, e.g., events having the same occurrence step and the overlapping event time blocks. When all the events are adopted as display targets with respective to the same step and the same time, visibility may be degraded. Accordingly, the number of the events which can be displayed with respect to the same step and the same time is preferably limited to N or less (N is an integer of 2 or more). However, since the event adopted as a display target under the limit is the event corresponding to at least one of an event having a relatively high priority and an event having a relatively short event time block, it can be expected that a more appropriate event is preferentially displayed.

Note that the “occurrence step” is a step in which the event has occurred, but one or more steps may also be the “occurrence steps”. In other words, the occurrence step may be one or more steps. Accordingly, a first event (any event) and a second event (any event other than the first event) which have “the same occurrence step” may indicate that at least one of the occurrence steps of the first event and at least one of the occurrence steps of the second event are the same step.

Also, the first event and the second event which have “the overlapping event time blocks” mean that a time block corresponding to at least a portion of the event time block of the first event and a time block corresponding to at least a portion of the event time block of the second event are the same time block. Accordingly, the event time block of one of the first event and the second event may also be completely or partially included in the event time block of the other of the first event and the second event.

In addition, the N (N is an integer of 2 or more) event display objects respectively corresponding to the N events among the events having the same occurrence step and having the overlapping event time blocks are arranged in parallel with the step axis with respect the same occurrence step. This allows the user browsing through the diagram chart 170 to be notified of the N events occurred in given overlapping time blocks with respect to the same step. Note that, in accordance with at least one of the number of the events adopted as the display targets with respect to the same step and the same time and the priorities thereof, the height (height of the band) of the event display object of each of the events may be determined by the management server program 271. According to the example in FIG. 13, when there are two events as the display targets with respect to the same time, the height of the event display object is adjusted to ½ of the height of the event display object when the event as the display target is one.

<Display Mode (m5): Display of Changing Tendency of Retention>

The “display of changing tendency of retention” is displaying the changing tendency of the retention period in each inter-step range (and/or in each intra-step range). Specifically, the “display of changing tendency of retention” is performing the accentuated display of a changing tendency satisfying a requirement corresponding to an increasing tendency or a requirement corresponding to a decreasing tendency when such a changing tendency is found.

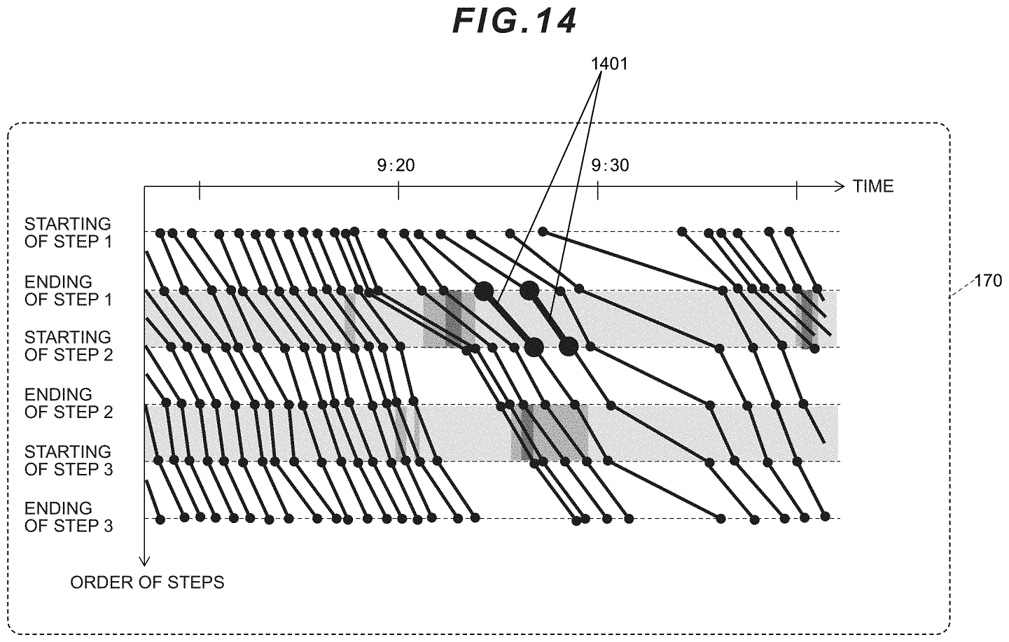

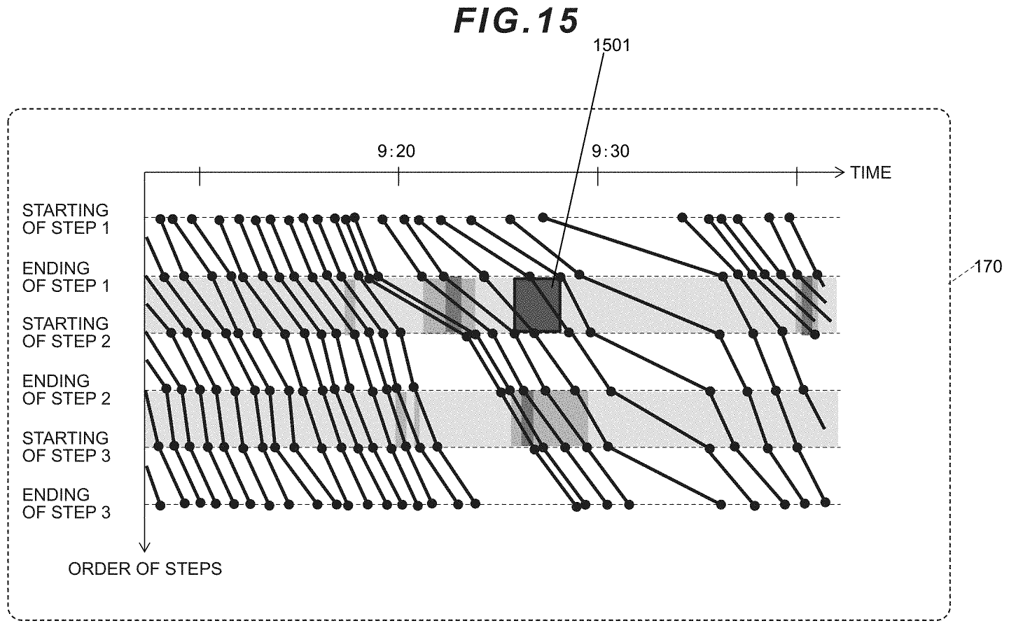

FIG. 14 shows an example of the display of the changing tendency of retention. FIG. 15 shows another example of the display of the changing tendency of retention.

The display shown by way of example in FIG. 14 or FIG. 15 may be performed when the achievement of the present display mode (m5) is specified by the user or settings which allow the display to be performed may also be made in advance. The management server program 271 specifies, for each of two or more consecutive products during the display target period and on a per step basis, an intra-step retention period as the period from the starting time of each of the steps to the ending time of the step and/or an inter-step retention period as the period from the ending time of the step to the starting time of the subsequent step on the basis of the past record table 351. The management server program 271 determines whether or not there is the changing tendency of retention satisfying a predetermined requirement on the basis of each intra-step retention period and/or each inter-step retention period specified for each of the two or more products. When there is the satisfying changing tendency, the management server program 271 performs the accentuated display of the display object to which the satisfying changing tendency belongs.

For example, when only the display mode (m1) is adopted as the display mode to be achieved, the occurrence of the trouble retention situation (e.g., the warning retention situation or the abnormal retention situation) can be recognized by visual inspection. However, it is difficult to predict whether or not any trouble retention situation will occur again after this trouble retention situation and, if any, the time at which the future trouble retention situation will occur. It can be considered that the problem encountered is more serious particularly when the display target period is long and therefore the time axis is compressed, as described above.

In the present display mode (m5), when there is the changing tendency of retention satisfying the predetermined requirement, the display object to which the changing tendency belongs is subjected to the accentuated display. Accordingly, by comparing the display object to the display position of the trouble retention situation, it is possible to predict the occurrence of trouble after the current trouble retention situation.

Note that the display object to which the changing tendency satisfying the predetermined requirement belongs may be such a newly produced display object as to be displayed so as to overlap the diagram chart 170. In the present embodiment, such a display object is at least one of display objects (x) and (y) shown below. According to FIGS. 14 and 15, either one of the display objects (x) and (y) corresponds to such a display object. The display object (x) is a line segment 1401 shown by way of example in FIG. 14. The display object (y) is a rectangular portion 1501 shown by way of example in FIG. 15. Thus, it can be expected to maintain visibility by using the display objects present on the diagram chart 170 to display the changing tendency irrespective of whether or not the present display mode (m5) is adopted.

(x) in the inter-step band (and/or intra-step band) to which the satisfying changing tendency belongs, a line segment to which the satisfying changing tendency belongs among two or more line segments respectively corresponding to the two or more products; and

(y) in the inter-step band (and/or intra-step band) to which the satisfying changing tendency belongs, a rectangular portion having a width corresponding to a time block to which the satisfying changing tendency belongs.

The following will describe an example of a method of specifying the changing tendency. Note that, in the following description, a product having a product ID: a may be referred to as the “product α”.

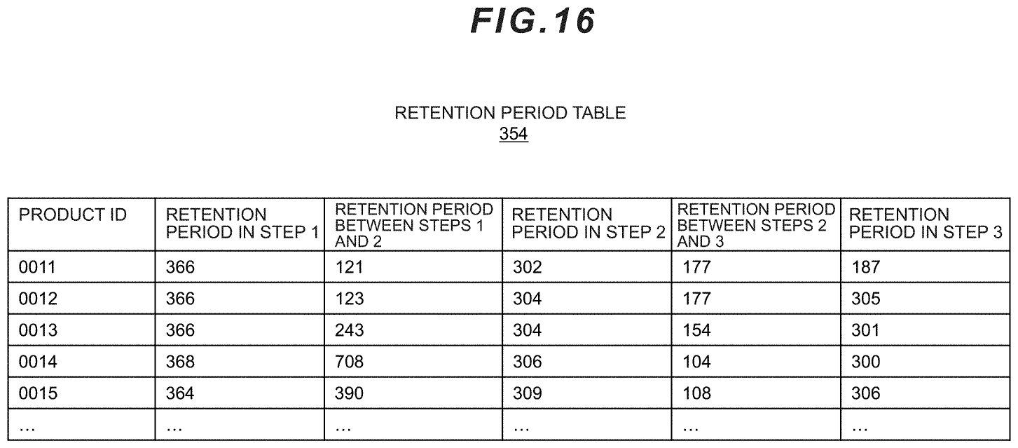

First, the management server program 271 specifies, for each of the two or more consecutive products during the display target period and on a per step basis, the intra-step retention period as the period from the starting time of each of the steps to the ending time of the step and the inter-step retention period as the period from the ending time of the step to the starting time of the subsequent step on the basis of the past record table 351. The management server program 271 records, for each product, the intra-step retention period and the inter-step retention period of each of the steps in the retention period table 354. As shown in FIG. 16, the retention period table 354 holds, for each product, the product ID and information showing the intra-step retention period and the inter-step retention period of each of the steps. Note that the values shown by way of example in FIG. 16 are calculated from the past record table 351 shown by way of example in FIG. 5. For example, in the inter-step range 1-2, the inter-step retention period of the product 0011 is “121” (measured in seconds) from the ending time “2017/6/30 13:22:12” of step 1 to the starting step “2017/6/30 13:29:13” of step 2.

Next, the management server program 271 performs, for each of the two or more consecutive products mentioned above other than the leading one, processes (m1) and/or (m2) shown below.

(m1) The management server program 271 specifies, for each intra-step range, an intra-step difference as a value obtained by subtracting the intra-step retention period of the product from the intra-step retention period of the product previous to the product.

(m2) The management server program 271 specifies, for each inter-step range, an inter-step difference as a value obtained by subtracting the inter-step retention period of the product from the inter-step retention period of the product previous to the product.

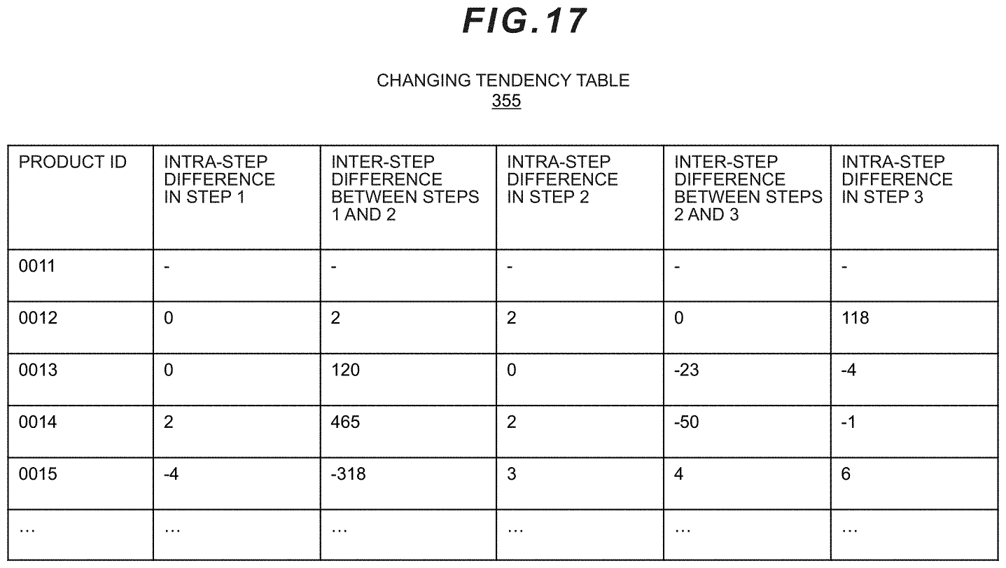

The management server program 271 records, for each product other than the leading product, the specified intra-step difference and/or inter-step difference in the changing tendency table 355 on a per step basis. As shown in FIG. 17, the changing tendency table 355 holds, for each product, a production ID and information showing the intra-step difference and the inter-step difference in each of the steps. Note that the values shown by way of example in FIG. 17 are calculated from the retention period table 354 shown by way of example in FIG. 16. For example, a value obtained by subtracting the intra-step retention period “366” of the product 0011 from the intra-step retention period “366” of the product 0012 for the range in step 1 is “0”. Also, for example, a value obtained by subtracting the inter-step retention period “121” of the product 0011 from the inter-step retention period “123” of the product 0012 for the inter-step range 1-2 is “2”.

The satisfying changing tendency is any of tendencies (a) to (d) shown below (e.g., the probability that any of the tendencies has consecutively occurred N times (N is a natural number) or has occurred in a given period has a given value or more) and, in each of the tendencies (a) to (d), at least one of the intra-step difference or inter-step difference of the product and the intra-step difference or inter-step difference of the subsequent product has an absolute value equal to or larger than a threshold.

(a) With respect to any intra-step range or inter-step range, the sum of the intra-step difference or inter-step difference of each of the products and the intra-step difference or inter-step difference of the subsequent product is positive, and the intra-step difference or inter-step difference of the subsequent product is also positive.

(b) With respect to any intra-step range or inter-step range, the sum of the intra-step difference or inter-step difference of each of the products and the intra-step difference or inter-step difference of the subsequent product is negative, and the intra-step difference or inter-step difference of the subsequent product is also negative.

(c) With respect to any intra-step range or inter-step range, the sum of the intra-step difference or inter-step difference of each of the products and the intra-step difference or inter-step difference of the subsequent product is positive, while the intra-step difference or inter-step difference of the subsequent product is negative.

(d) With respect to any intra-step range or inter-step range, the sum of the intra-step difference or inter-step difference of each of the products and the intra-step difference or inter-step difference of the subsequent product is negative, while the intra-step difference or inter-step difference of the subsequent product is positive.

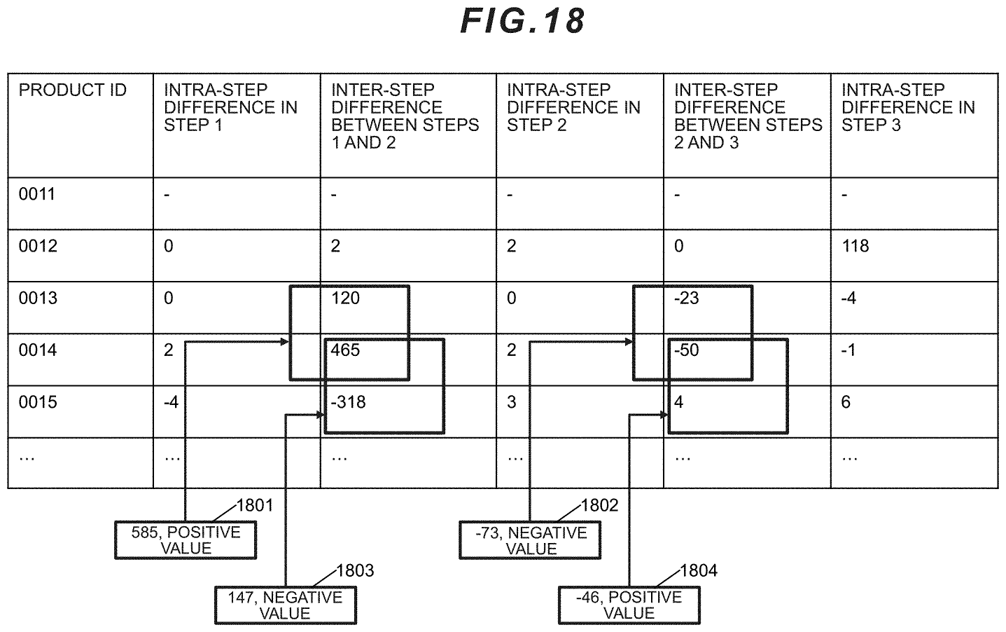

FIG. 18 shows an example of each of the tendencies (a) to (d). It is assumed that, in FIG. 18, of the intra-step difference and the inter-step difference, the inter-step difference is a use target. It is also assumed that, in the description of FIG. 18, the threshold compared to the absolute value of the inter-step difference is “5”.

A reference sign 1801 shows an example of the tendency (a). Specifically, in the inter-step range 1-2, the absolute value of each of the inter-step difference “120” of the product 0013 and the inter-step difference “465” of the subsequent product 0014 is equal to or larger than the threshold “5”. The sum of the inter-step difference “120” of the product 0013 and the inter-step difference “485” of the product 0014 is a positive value “585”. The inter-step difference “485” of the product 0014 subsequent to the product 0013 is also a positive value. Such a result shows that, in the inter-step range 1-2, the inclinations of the line segments tend to decrease with regard to the products 0013 and 0014. In other words, the retention period tends to increase.

A reference sign 1802 shows an example of the tendency (b). Specifically, in the inter-step range 2-3, the absolute value of each of the inter-step difference “−23” of the product 0013 and the inter-step difference “−50” of the subsequent product 0014 is equal to or larger than “5”. The sum of the inter-step difference “−23” of the product 0013 and the inter-step difference “−50” of the product 0014 is a negative value “−73”. The inter-step difference “−50” of the product 0014 subsequent to the product 0013 is also a negative value. Such a result shows that, in the inter-step range 2-3, the inclinations of the line segments tend to increase with regard to the products 0013 and 0014. In other words, the retention period tends to decrease.

A reference sign 1803 shows an example of the tendency (c). Specifically, in the inter-step range 1-2, the absolute value of each of the inter-step difference “465” of the product 0014 and the inter-step difference “−318” of the subsequent product 0015 is equal to or larger than “5”. The sum of the inter-step difference “465” of the product 0014 and the inter-step difference “−318” of the product 0015 is a positive value “147”. However, the inter-step difference “−318” of the product 0015 subsequent to the product 0014 is a negative value. Such a result shows that, in the inter-step range 1-2, the retention period has abruptly increased with regard to the products 0014 and 0015 or, in other words, the increase of the retention period is maintained.

A reference sign 1804 shows an example of the tendency (d). Specifically, in the inter-step range 2-3, the absolute value of the inter-step difference “−50” of the product 0014 is equal to or larger than “5”. The sum of the inter-step difference “−50” of the product 0014 and the inter-step difference “4” of the product 0015 is a negative value “−46”. However, the inter-step difference “4” of the product 0015 subsequent to the product 0014 is a positive value. Such a result shows that, in the inter-step range 2-3, the retention period has temporarily decreased with regard to the products 0014 and 0015 or, in other words, the decrease of the retention period is maintained.

The foregoing is the description of the display modes (m1) to (m5).

The time block as a range in which the presence or absence of the trouble retention situation is examined (and the time block as a range in which the presence or absence of the changing tendency satisfying the predetermined requirement is examined) may be the whole display target period but, in that case, it may be difficult to recognize the relation to a real event. Accordingly, in the present embodiment, the time block as the range in which the presence or absence of the trouble retention situation is examined (and the time block as the range in which the presence or absence of the changing tendency satisfying the predetermined requirement is examined) is within at least one analysis time block. The analysis time block is the time block defined as an analysis target and including the event time block of at least one of all the events shown by at least any event data having the event time block belonging to the display target period. In other words, in the present embodiment, such an examination target range can be narrowed down to the analysis time block as a portion of the display target period using the event table 352.

The following will describe an example of a method of determining the analysis time block.

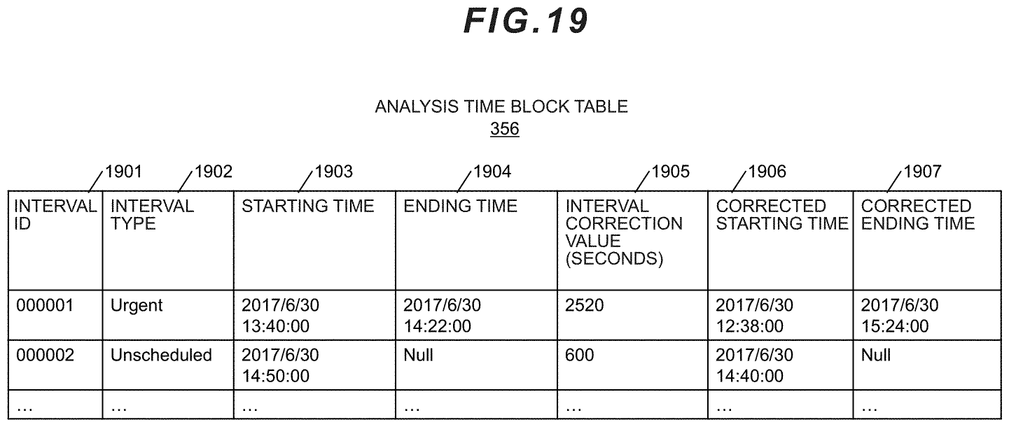

FIG. 19 shows the analysis time block table 356.

The analysis time block table 356 has records for the individual analysis time blocks on a one-to-one basis. Each of the records holds information such as an interval ID 1901, an interval type 1902, a starting time 1903, an ending time 1904, an interval correction value 1905, a post-correction starting time 1906, and a post-correction ending time 1907. The following will take one analysis time block as an example (“target analysis time block” in the description of FIG. 19).

The interval ID 1901 shows the ID of the target analysis time block. The interval type 1902 shows the event type of the event on the basis of which the target analysis time block is determined. The starting time 1903 shows the starting time of the event. The ending time 1904 shows the ending time of the event. The interval correction value 1905 shows an interval correction value as the period determined on the basis of at least one of the starting time and the ending time of the event. The post-correction starting time 1906 shows the starting time of the target analysis time block, specifically the time obtained as a result of reflecting the interval correction value on the starting time of the event. The post-correction ending time 1907 shows the ending time of the target analysis time block, specifically the time obtained as a result of reflecting the interval correction value on the ending time of the event.

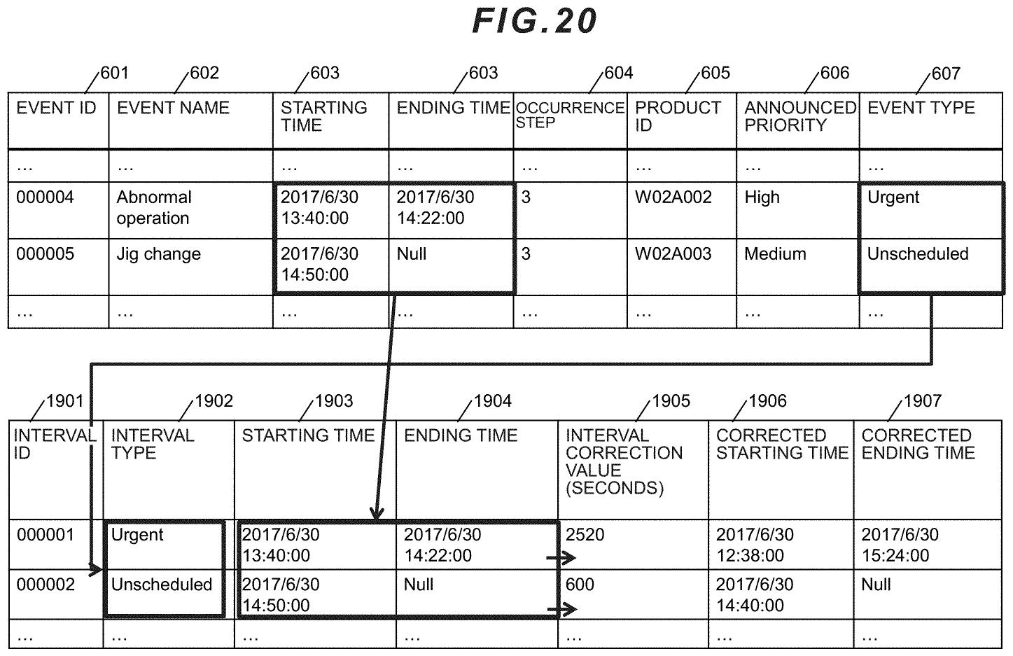

FIG. 20 shows an example of the determination of the analysis time block.

The management server program 271 specifies the event the event type 608 of which has a predetermined value (e.g., “Unscheduled” or “Urgent”) in the event table 352. In the following description of FIG. 20, one event is taken as an example.

The management server program 271 records, among the records corresponding to the specified event, the event type 608, the starting time 603, and the ending time 604 as the interval type 1902, the starting time 1903, and the ending time 1904 in the records of the analysis time block table 356.

The management server program 271 determines the interval correction value. Specifically, when, e.g., the ending time 1904 is not “Null”, the management server program 271 determines that the period from the starting time 1903 to the ending time 1904 is the interval correction value. When the ending time 1904 is “Null”, the management server program 271 determines that a predetermined value (e.g., “600”) is the interval correction value. The management server program 271 records the determined interval correction value as the interval correction value 1905.

Then, the management server program 271 determines the analysis time block. Specifically, for example, the management server program 271 records the time previous to the starting time 1903 by the interval correction value 1905 as the post-correction starting time 1906. The management server program 271 also records the time after the lapse of the interval correction value 1905 from the ending time 1904 as the post-correction ending time 1907. In other words, in this example, the analysis time block is a time block including the event time block and the interval correction values respectively added on at the beginning and ending thereof.

While the embodiment of the present invention has been described heretofore, the embodiment is an example for describing the present invention and is not intended to limit the scope of the present invention to the embodiment. The present invention can be implemented even in various other forms.

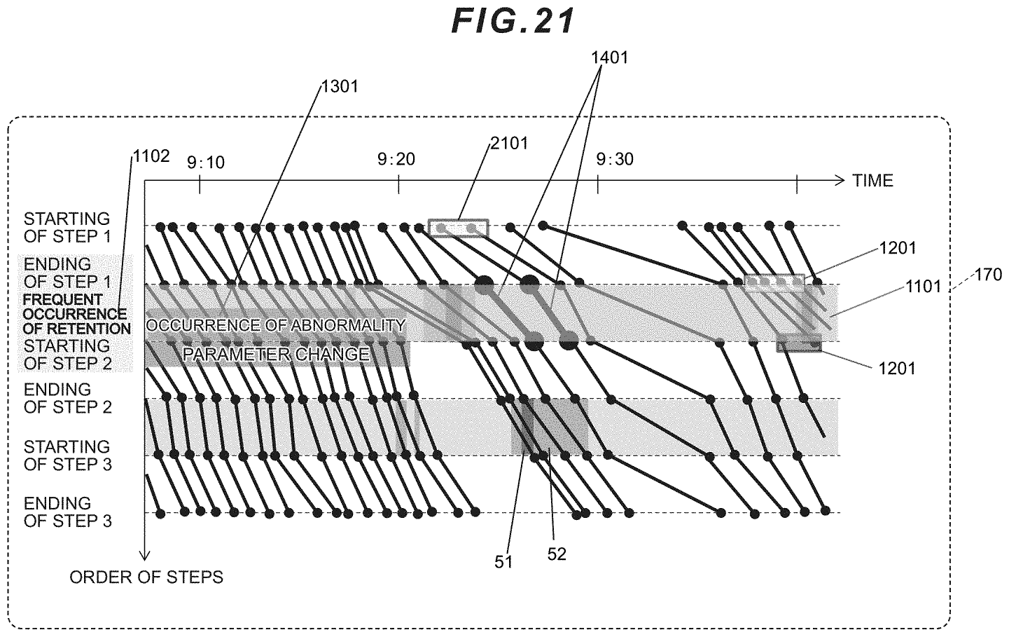

For example, instead of displaying the starting time and the ending time of each step on the diagram chart 170, it may also be possible to display the execution time (starting time or ending time) of each step, as shown by way of example in FIG. 21. In this case also, any of the display modes (m1) to (m5) can be adopted. For example, even when the display mode (m1) is adopted, in the inter-step range, the rectangular portion 51 corresponding to the warning retention situation and the rectangular portions 52 corresponding to the abnormal retention situation may be subjected to the accentuated display (e.g., see an inter-step range 4-5). Also, in the inter-step range (e.g., in step 1), the warning retention situation and the abnormal retention situation may be subjected to the accentuated display. A reference sign 2101 in FIG. 21 denotes a display object showing the warning retention situation in the range in step 1. Also, when the display mode (m2) is adopted, the display objects 1101 and 1102 showing the relatively high frequency of the abnormal retention situation can be displayed in the inter-step range 2-3 in which the frequency of the abnormal retention situation is relatively high. Also, when the display mode (m3) is adopted, the affected interval display object 1201 can be displayed for the target time group. Also, when the display mode (m4) is adopted, the event display object 1301 can be displayed. Also, when the display mode (m5) is adopted, the display object 1401 belonging to the changing tendency can be subjected to the accentuated display.

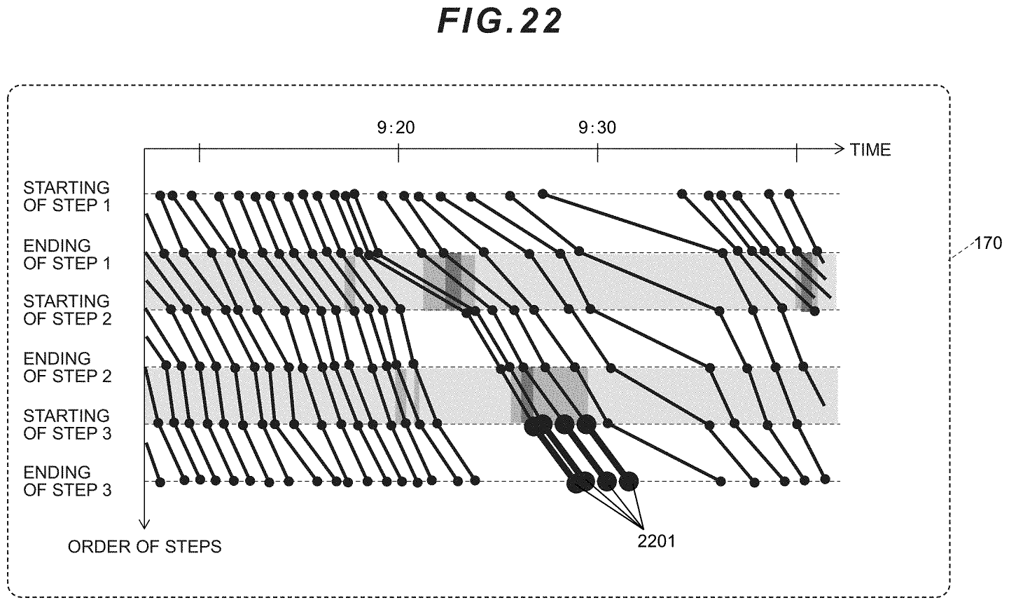

Also, for example, the management server program 271 may determine, for each product, whether or not the retention periods in each inter-step range and each intra-step range are equal to or larger than a predetermined threshold (e.g., the threshold included in the related information 281, which is the threshold for the retention period set by the user). When there are a product and an inter-step range (or an intra-step range) which have the retention period equal to or larger than the threshold, the management server program 271 may perform, for the product, the accentuated display of a line segment 2201 subsequent to the inter-step range (or intra-step range), as shown by way of example in FIG. 22.

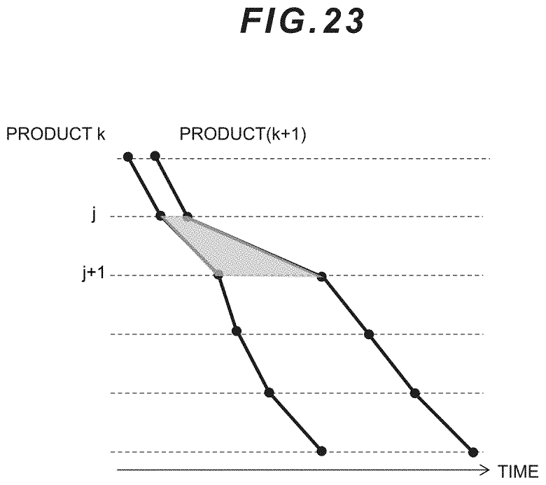

Also, for example, instead of or in addition to limiting the range in which the occurrence or non-occurrence of the trouble retention situation (e.g., the excess situation or the over-reduction situation) is examined to the time block satisfying the requirement for the analysis time block described above, the management server program 271 may also limit the range to a time block and/or an inter-step range (or intra-step range) satisfying a predetermined requirement other than the requirement for the analysis time block. As the “predetermined requirement”, the time block and/or the inter-step range (or intra-step range) to which the blank region determined to be the accentuated display target belongs can be adopted. The definition of the blank region is as shown in, e.g., FIG. 23. Specifically, the blank region is a region bounded by four points (coordinates) shown below which are:
the point corresponding to a product k and coordinates j;
the point corresponding to the product k and coordinates (j+1);
the point corresponding to a product (k+1) and the coordinates j; and
the point corresponding to the product (k+1) and the coordinates (j+1).

The product k and the product (k+1) are an example of two consecutive products. In the case where the starting time and the ending time of each step are displayed (e.g., in FIG. 1), when the coordinates j correspond to the starting time of a given step (starting time of a given intra-step range), the coordinates (j+1) correspond to the ending time of the given step (starting time of a given inter-step range). In the case where the execution time (starting time or ending time) of each step is displayed (e.g., in FIG. 21), when the coordinates j correspond to the execution time of a given step, the coordinates (j+1) correspond to the execution time of the step subsequent to the given step.

What is claimed is:

1. A production management supporting system, comprising:
an interface portion including one or more interfaces;
a storing portion including one or more memories, the storing portion storing past record information that includes information as a past record which shows, for each product loaded in a production line in which a plurality of steps are performed, an execution time of each of the steps and that serves as a basis for a diagram chart showing a production situation; and
a processor portion coupled to the interface portion and to the storing portion, wherein
the diagram chart is a polygonal line graph having a first axis and a second axis perpendicular to the first axis,
the first axis corresponds to time,
the second axis corresponds to the steps,
the diagram chart has a polygonal line for each product for which at least one of the plurality of steps has the execution time belonging to a display target period,
a point on each polygonal line corresponds to the step and the execution time of the step,
the execution time of each of the steps in the past record information is at least one of a starting time and an ending time of the step, and
the processor portion
specifies, for each of one or more times during the display target period and on a per inter-step and/or intra-step range basis, a retention number as the number of products present at the time on the basis of the past record information;
determines whether or not one or more retention situations in accordance with the retention number specified for each of the one or more times on a per inter-step and/or intra-step range basis include a retention situation satisfying a predetermined requirement; and
performs, when there is the satisfying retention situation, accentuated display of a target portion that is a portion, of the diagram chart, which corresponds to an inter-step range and/or an intra-step range in which the satisfying retention situation has occurred and to a period having the satisfying retention situation.

2. The production management supporting system according to claim 1, wherein,
in the past record information, the execution time of each of the steps is the starting time and the ending time of the step,
in the diagram chart, in a sequential order of the steps, starting axes corresponding to the starting times and parallel with the first axis and ending axes corresponding to the ending times and parallel with the first axis are alternately arranged along a direction perpendicular to the first axis, and consequently intra-step bands and inter-step bands are alternately arranged along a direction parallel with the second axis, each of the intra-step bands being a band-like region extending in parallel with the first axis from the starting axis to the ending axis and corresponding to the intra-step range from starting of the step to ending of the step, each of the inter-step bands being a band-like region extending in parallel with the first axis from the ending axis to the starting axis and corresponding to the inter-step range from the ending of the step to starting of a subsequent step, and
the accentuated display of the target portion is accentuated display of a rectangular portion corresponding to a period having the satisfying retention situation in the inter-step band or the intra-step band corresponding to the inter-step range or the intra-step range in which the satisfying retention situation has occurred.

3. The production management supporting system according to claim 2, wherein a display mode of each of the inter-step bands is different from a display mode of each of the intra-step bands.

4. The production management supporting system according to claim 2, wherein the satisfying retention situation is either a situation in which the retention number is equal to or larger than a first threshold or a situation in which the retention number is less than a second threshold smaller than the first threshold, in any inter-step range and/or in any intra-step range.

5. The production management supporting system according to claim 4, wherein, in at least one inter-step range and/or in at least one intra-step range, at least one of the first threshold and the second threshold is a value depending on the inter-step range and/or the intra-step range.

6. The production management supporting system according to claim 2, wherein the respective inter-step bands and the respective intra-step bands have uniform lengths along the second axis.

7. The production management supporting system according to claim 2, wherein, when there are two or more inter-step and/or intra-step ranges in which the satisfying retention situation has occurred, the processor portion performs accentuated display of an inter-step range and/or an intra-step range in which a frequency that is at least one of the number of occurrences and a cumulative period of the satisfying retention situation is relatively high, among the two or more inter-step and/or intra-step ranges.

8. The production management supporting system according to claim 2, wherein
the processor portion
determines, for at least one of the steps, the presence or absence of a target time group on the basis of the past record information,
the target time group being at least one of an ending time group and a starting time group for the at least one step,
the ending time group for the at least one step being two or more ending times that form an ending time interval shorter than a starting time interval for the subsequent step, and respectively correspond to two or more consecutive products,
the starting time group for the at least one step being two or more starting times that form a starting time interval longer than an ending time interval for a previous step, and respectively correspond to two or more consecutive products, and
performs, when there is the target time group, accentuated display of two or more points respectively corresponding to the two or more times forming the target time group and/or displays a display object covering the two or more points such that the display object overlaps the two or more points or as a background of the two or more points.

9. The production management supporting system according to claim 8, wherein
the at least one step is a step forming an inter-step range or an intra-step range to which the satisfying retention situation belongs, and
the presence or absence of the target time group is determined for an affected time block which is a time block including at least a portion of the period having the satisfying retention situation.

10. The production management supporting system according to claim 2, wherein
the processor portion
specifies, for each of two or more consecutive products during the display target period and on a per step basis, an intra-step retention period that is a period from the starting time of each of the steps to the ending time of the step and/or an inter-step retention period that is a period from the ending time of the step to the starting time of the subsequent step on the basis of the past record information;
determines whether or not there is a changing tendency of retention satisfying a predetermined requirement on the basis of the intra-step retention period and/or the inter-step retention period specified for each of the two or more products; and
performs, when there is the satisfying changing tendency, accentuated display of a display object to which the satisfying changing tendency belongs.

11. The production management supporting system according to claim 10, wherein the display object to which the satisfying changing tendency belongs is at least one of items (x) and (y) shown below:
(x) in the inter-step band and/or the intra-step band to which the satisfying changing tendency belongs, a line segment to which the satisfying changing tendency belongs among two or more line segments respectively corresponding to the two or more products; and
(y) in the inter-step band and/or the intra-step band to which the satisfying changing tendency belongs, a rectangular portion having a width corresponding to a time block to which the satisfying changing tendency belongs.

12. The production management supporting system according to claim 10, wherein
for each of the two or more products other than a leading product, the processor portion:
specifies, on a per intra-step range basis, an intra-step difference having a value obtained by subtracting an intra-step retention period of the product from an intra-step retention period of a product previous to the product; and/or
specifies, on a per inter-step range basis, an inter-step difference having a value obtained by subtracting an inter-step retention period of the product from an inter-step retention period of a product previous to the product, and
the satisfying changing tendency is any of tendencies (a) to (d) shown below and, in each of the tendencies (a) to (d), and at least one of the intra-step difference or inter-step difference of the product and the intra-step difference or inter-step difference of the subsequent product is an intra-step difference or an inter-step difference having an absolute value equal to or larger than a threshold:
(a) with respect to any intra-step range or inter-step range, a sum of the intra-step difference or inter-step difference of each of the products and the intra-step difference or inter-step difference of the subsequent product is positive, and the intra-step difference or inter-step difference of the subsequent product is also positive;
(b) with respect to any intra-step range or inter-step range, the sum of the intra-step difference or inter-step difference of each of the products and the intra-step difference or inter-step difference of the subsequent product is negative, and the intra-step difference or inter-step difference of the subsequent product is also negative;
(c) with respect to any intra-step range or inter-step range, the sum of the intra-step difference or inter-step difference of each of the products and the intra-step difference or inter-step difference of the subsequent product is positive, while the intra-step difference or inter-step difference of the subsequent product is negative; and
(d) with respect to any intra-step range or inter-step range, the sum of the intra-step difference or inter-step difference of each of the products and the intra-step difference or inter-step difference of the subsequent product is negative, while the intra-step difference or inter-step difference of the subsequent product is positive.

13. The production management supporting system according to claim 1, wherein the satisfying retention situation is either a situation in which the retention number is equal to or larger than a first threshold or a situation in which the retention number is less than a second threshold smaller than the first threshold, in the inter-step range or the intra-step range.

14. The production management supporting system according to claim 1, wherein
the processor portion
specifies, for each of two or more consecutive products during the display target period and on a per step basis, a retention period that is a period from the execution time of each of the steps to the execution time of a subsequent step on the basis of the past record information;
determines whether or not there is a changing tendency of retention satisfying a predetermined requirement on the basis of the retention period specified for each of the two or more products; and
performs, when there is the satisfying changing tendency, accentuated display of a display object to which the satisfying changing tendency belongs.

15. The production management supporting system according to claim 1, wherein
the storing portion stores event information including, for each event, event data having information showing an event time block including, among a starting time and an ending time of the event, at least the starting time, and an occurrence step in which the event has occurred, and
the processor portion
determines, when there is the satisfying retention situation, the presence or absence of an event satisfying requirements (c1) and (c2) shown below on the basis of the event information:
(c1) the occurrence step belongs to the inter-step and/or intra-step range in which the satisfying retention situation has occurred; and
(c2) at least a portion of the event time block of the event belongs to a time block including at least a portion of a period having the satisfying retention situation, and
Superimposes, when there is the event, an event display object as a display object having a length corresponding to the event time block of the event and parallel with the first axis, on a position on the diagram chart corresponding to the step coincident with the occurrence step of the event and to the event time block of the event.

16. The production management supporting system according to claim 1, wherein
the storing portion stores event information including, for each event, event data having information showing an event time block including, among an occurrence time and an ending time of the event, at least the occurrence time, and an occurrence step in which the event has occurred, and
the one or more times are in an analysis time block that is a time block defined as an analysis target and including an event time block of at least one of all the events shown by at least any event data having the event time block belonging to the display target period.

17. A production management supporting method, comprising the steps of:
specifying, for each of one or more times during a display target period and on a per intra-step and/or inter-step range basis, a retention number as the number of products present at the time on the basis of past record information that includes information as a past record which shows, for each product loaded in a production line in which a plurality of steps are performed, an execution time of each of the steps and that serves as a basis for a diagram chart showing a production situation;
the diagram chart being a polygonal line graph having a first axis and a second axis perpendicular to the first axis,
the first axis corresponding to time,
the second axis corresponding to the steps,
the diagram chart having a polygonal line for each product for which at least one of the plurality of steps has the execution time belonging to the display target period,
a point on each polygonal line corresponding to the step and the execution time of the step, and
the execution time of each of the steps in the past record information being at least one of a starting time and an ending time of the step,
determining whether or not one or more retention situations in accordance with the retention number specified for each of the one or more times on a per inter-step and/or intra-step range basis include a retention situation satisfying a predetermined requirement; and
performing, when there is the satisfying retention situation, accentuated display of a target portion that is a portion, of the diagram chart, which corresponds to an inter-step range and/or an intra-step range in which the satisfying retention situation has occurred and to a period having the satisfying retention situation.

18. A computer program for causing a computer to perform the steps of:
specifying, for each of one or more times during a display target period and on a per intra-step and/or inter-step range basis, a retention number as the number of products present at the time on the basis of past record information that includes information as a past record which shows, for each product loaded in a production line in which a plurality of steps are performed, an execution time of each of the steps and that serves as a basis for a diagram chart showing a production situation;
the diagram chart being a polygonal line graph having a first axis and a second axis perpendicular to the first axis,
the first axis corresponding to time,
the second axis corresponding to the steps,
the diagram chart having a polygonal line for each product for which at least one of the plurality of steps has the execution time belonging to the display target period,
a point on each polygonal line corresponding to the step and the execution time of the step, and
the execution time of each of the steps in the past record information being at least one of a starting time and an ending time of the step,
determining whether or not one or more retention situations in accordance with the retention number specified for each of the one or more times on a per inter-step and/or intra-step range basis include a retention situation satisfying a predetermined requirement; and
performing, when there is the satisfying retention situation, accentuated display of a target portion that is a portion, of the diagram chart, which corresponds to an inter-step range and/or an intra-step range in which the satisfying retention situation has occurred and to a period having the satisfying retention situation.
